(19) United States
(12) Patent Application Publication
(10) Pub. No.: US 2024/0019393 A1
(43) Pub. Date: Jan. 18, 2024

(54) ELECTROCHEMICAL SENSOR SYSTEM AND METHOD FOR URIC ACID MEASUREMENT

(71) Applicant: Purdue Research Foundation, West Lafayette, IN (US)

(72) Inventors: Wenzhuo Wu, West Lafayette, IN (US); Jing Jiang, West Lafayette, IN (US)

(21) Appl. No.: 18/373,412

(22) Filed: Sep. 27, 2023

Related U.S. Application Data
(63) Continuation-in-part of application No. 17/849,840, filed on Jun. 27, 2022.
(60) Provisional application No. 63/237,814, filed on Aug. 27, 2021.

(51) Int. Cl. G01N 27/30

(52) U.S. Cl. CPC G01N 27/30

(57) ABSTRACT

An electrochemical sensor that includes a substrate and a piezoelectric semiconductor which is configured to detect uric acid using piezo-electrocatalysis. The piezoelectric semiconductor is coupled to the substrate. The piezoelectric semiconductor includes a nanostructured semiconducting ZnO catalyst. The nanostructured semiconducting ZnO catalyst has a noncentrosymmetric wurtzite configuration. The nanostructured semiconducting ZnO catalyst is shaped as a nanorod and/or a nanosheet.

### CROSS REFERENCE TO RELATED APPLICATIONS

This application is a Continuation-in-Part of U.S. application Ser. No. 17/849,840, filed on Jun. 27, 2022, which in turn claims the benefit of U.S. Provisional Application Ser. No. 63/237,814, filed on Aug. 27, 2021. The entire disclosure of the above application is hereby incorporated herein by reference.

### GOVERNMENT RIGHTS

This invention was made with government support under DE-AC07-05ID14517 awarded by the Department of Energy. The government has certain rights in the invention.

### FIELD

The present disclosure relates to sensors and, more particularly, to electrochemical sensors.

### INTRODUCTION

This section provides background information related to the present disclosure which is not necessarily prior art.

L-ascorbic acid (AA) is a critical nutrient for many organisms and an acidity regulator of antioxidants and preservatives. AA plays a vital role in biological metabolisms, e.g., the digestion of amino acids, as well as the synthesis of adrenalin, certain hormones, and neurotransmitters. AA has also been commonly used for the prevention and treatment of scurvy, cancer, common cold, and AIDS, etc. The design and implementation of cost-effective, high-performance electrochemical sensors for the rapid and accurate quantification of AA concentration in foods or biological fluids are important for many societally pervasive applications such as clinical diagnostics, wearable health monitoring, food safety, and environmental monitoring. However, the direct electro-oxidation of AA on the surface of the bare electrodes is irreversible. Moreover, the subsequent hydrolysis of the reaction will cause electrode fouling with large overpotential, poor selectivity, low sensitivity, and unsatisfactory reproducibility.

Nanostructured catalysts with large specific surfaces and abundant active sites appeal to highly sensitive electrochemical sensing of various chemicals. Various nanomaterials, such as conducting polymers, carbon materials, and metal oxides, have been explored for modifying the electrodes to efficiently detect AA, leveraging the enhanced active sites, improved interfacial charge transfer, and/or intrinsic conductivity in the related nanostructures. For example, Jiang et al. used liquid-phase exfoliated graphene to fabricate an AA sensor, which showed a linear detection range from 9 μM to 2314 μM with a detection limit of 6.45 μM. Recently, Mei et al. demonstrated the sensitive detection of AA with metal oxide nanomembranes and achieved a detection range of 1-30 μM. However, the preparation of these nanoengineered catalysts is complicated, usually involving high temperature or strict gas control. The catalyst yield is usually low, and the catalyst is also prone to be oxidized, reduced, or decomposed. Meanwhile, due to the use of expensive materials such as precious metals, biomaterials, complex instruments, and harsh control conditions, the cost of producing nanostructured AA catalysts is typically high. The design and implementation of cost-effective, high-performance electrochemical sensors for detecting AA remain a significant challenge.

### SUMMARY

In concordance with the instant disclosure, a cost-effective, high-performance electrochemical sensor system and method for detecting AA, has been surprisingly discovered.

The sensor is configured to detect ascorbic acid using piezo-electrocatalysis. The sensor includes a substrate and a piezoelectric semiconductor. The piezoelectric semiconductor may be coupled to the substrate. The piezoelectric semiconductor may also include a nanostructured semiconducting zinc oxide catalyst. In certain circumstances, the nanostructured semiconducting zinc oxide catalyst may have a noncentrosymmetric wurtzite configuration.

In another embodiment, the present technology includes methods of manufacturing the sensor. For instance, a method of manufacturing the sensor may include providing a substrate. Next, the method may include disposing the substrate in a seed solution. It is also contemplated for the seed solution to be disposed onto the substrate. The seed solution may include zinc. The seed solution may be configured to produce a zinc oxide seed layer on the substrate. Then, the substrate with the zinc oxide seed layer may be disposed into a growth solution. The growth solution may be configured to form a semiconducting nanostructured zinc oxide catalyst on the substrate. Afterwards, a semiconducting nanostructured zinc oxide catalyst may be formed on the substrate.

Further areas of applicability will become apparent from the description provided herein. It should be understood that the description and specific examples are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a box diagram of a sensor including a substrate and a piezoelectric semiconductor, according to one embodiment of the present disclosure;

FIG. 2 is a top view from a scanning electron microscope image of a zinc oxide nanorod, according to one embodiment of the present disclosure;

FIG. 3 is a top view from a scanning electron microscope image of a zinc oxide nanosheet, according to one embodiment of the present disclosure;

FIG. 4 is another top view from a scanning electron microscope image of a zinc oxide nanorod, according to one embodiment of the present disclosure;

FIG. 5 is a top view of an energy dispersive spectroscopy mapping image, further depicting a distribution of zinc within the zinc oxide nanorods, according to one embodiment of the present disclosure;

FIG. 6 is a top view of an energy dispersive spectroscopy mapping image, further depicting a distribution of oxide within the zinc oxide nanorods, according to one embodiment of the present disclosure;

FIG. 7 is another top view from a scanning electron microscope image of a zinc oxide nanosheet, according to one embodiment of the present disclosure;

FIG. 8 is a top view of an energy dispersive spectroscopy mapping image, further depicting a distribution of zinc within the zinc oxide nanosheets, according to one embodiment of the present disclosure;

FIG. 9 is a top view an energy dispersive spectroscopy mapping image, further depicting a distribution of oxide within the zinc oxide nanosheets, according to one embodiment of the present disclosure;

FIG. 10 is a line graph illustrating an x-ray diffraction pattern of zinc oxide nanorods (ZnO NRs) and zinc oxide nanosheets (ZnO NSs), according to one embodiment of the present disclosure;

FIG. 11 is a line graph illustrating nitrogen adsorption and desorption isotherms of ZnO NRs and NSs, according to one embodiment of the present disclosure;

FIG. 12 is a top perspective view of a finite element method simulation image illustrating a piezoelectric potential distribution of a bottom-fixed and electrically grounded ZnO NR under an axial force, according to one embodiment of the present disclosure;

FIG. 13 is a top perspective view of a finite element method simulation image illustrating a piezoelectric potential distribution of a bottom-fixed and electrically grounded ZnO NR under a lateral force, according to one embodiment of the present disclosure;

FIG. 14 is a front elevational view of a finite element method simulation image illustrating a piezoelectric potential distribution of a bottom-fixed and electrically grounded ZnO NR under an axial force, according to one embodiment of the present disclosure;

FIG. 15 is a top perspective view of a finite element method simulation image illustrating a piezoelectric potential distribution of a ZnO NS under an axial force, according to one embodiment of the present disclosure;

FIG. 16 is a top perspective view of a finite element method simulation image illustrating a piezoelectric potential distribution of a ZnO NS under a lateral force, according to one embodiment of the present disclosure;

FIG. 17 is a front elevational view of a finite element method simulation image illustrating a piezoelectric potential distribution of a ZnO NS under a lateral force, according to one embodiment of the present disclosure;

FIG. 18 is a schematic diagram of a ZnO catalyst without polarization, according to one embodiment of the present disclosure;

FIG. 19 is a schematic diagram of a ZnO catalyst with electrocatalysis enhanced by a piezoelectric effect, further depicting a surface reaction under band tilting and strain, according to one embodiment of the present disclosure;

FIG. 20 is a front elevational view of a photograph illustrating an experimental setup of a piezoelectric ZnO/ITO-PET enhanced electrocatalysis of L-ascorbic acid (AA), according to one embodiment of the present disclosure;

FIG. 21 is a line graph illustrating the electrocatalysis of AA under 0.4% tensile strain in the presence of ZnO NRs and a control circumstance; according to one embodiment of the present disclosure;

FIG. 22 is a line graph illustrating the electrocatalysis of AA under 0.4% tensile strain in the presence of ZnO NSs and a control circumstance; according to one embodiment of the present disclosure;

FIG. 23 is a line graph illustrating the electrochemical impedance spectroscopy response of ZnO NRs and NSs, according to one embodiment of the present disclosure;

FIG. 24 is a bar graph illustrating the change rate of the reaction kinetics of AA catalysis before and after deformation of ZnO NRs and NSs, according to one embodiment of the present disclosure;

FIG. 25 is plot diagram illustrating a detection range width (mM) versus sensitivity (μA mM⁻¹ cm⁻²) of the piezoelectric ZnO NRs and NSs (under 0.4% strain) compared with various known catalysts;

FIG. 26 is a line graph illustrating the electrocatalysis of AA of ZnO NRs under different strain (0.2%, 0.4% and 0.6%), according to one embodiment of the present disclosure;

FIG. 27 is a line graph illustrating the electrocatalysis of AA of ZnO NSs under different strain (0.2%, 0.4% and 0.6%), according to one embodiment of the present disclosure;

FIG. 28 is a bar graph illustrating the reaction kinetics (ΔI=kC) of ZnO NRs and ZnO NSs under different strain (0.2%, 0.4% and 0.6%), according to one embodiment of the present disclosure;

FIG. 29 is a line graph illustrating the electrocatalysis of AA by 0.4% deformed ZnO NRs, according to one embodiment of the present disclosure;

FIG. 30 is a line graph illustrating the electrocatalysis of AA by 0.4% deformed NSs in the presence of different radical's scavengers, according to one embodiment of the present disclosure;

FIG. 31 is a bar graph illustrating the reaction kinetics (ΔI=kC) of 0.4% deformed ZnO NRs and NSs before and after adding different radical's scavengers, according to one embodiment of the present disclosure;

FIG. 32 is a front elevational, cross-sectional view of a scanning electron microscope image illustrating ZnO NRs, according to one embodiment of the present disclosure;

FIG. 33 is a top-plan view of an atomic-force microscopy image illustrating ZnO NSs, according to one embodiment of the present disclosure;

FIG. 34 is a line scan illustrating width and height parameters of the ZnO NSs along the line shown in FIG. 33, according to one embodiment of the present disclosure;

FIG. 35 is a line graph illustrating a room-temperature Raman spectra of ZnO NRs (blue) and ZnO NSs, according to one embodiment of the present disclosure;

FIG. 36 is a line graph illustrating a chronoamperograms of a ZnO NRs/ITO-PET electrode under 0.4% strain in 0.01 M NaOH solution at the potential of 0.4 V vs. Ag/AgCl, according to one embodiment of the present disclosure;

FIG. 37 is a line graph illustrating an amperometric response of the ZnO NRs/ITO-PET electrode under 0.4% strain at 0.4 V with additions of ascorbic acid and 2.0 mM different interfering species in 0.01 M NaOH solution, according to one embodiment of the present disclosure;

FIG. 38 is a table illustrating a performance comparison between the present disclosure and known electrochemical techniques for the detection of ascorbic acid;

FIG. 39 is a table illustrating a comparison of the sensing performance between the present disclosure and of different detection methods for the determination of ascorbic acid;

FIG. 40 is a flow chart illustrating a method of manufacturing the sensor, according to one embodiment of the present disclosure.

FIG. 41 is an expanded top perspective view of the sensor, further depicting the sensor having a drop-casted reduced-graphene-oxide (rGO) coating and provided on a flexible substrate, according to one embodiment of the present disclosure;

FIG. 42 is a scanning electron microscopy image of the ZnO NRs grown on the rGO-coated flexible substrate, according to one embodiment of the present disclosure;

FIG. 43 is an enlarged scanning electron microscopy image of the ZnO NRs grown on the rGO-coated flexible substrate, according to one embodiment of the present disclosure;

FIG. 44 is a scanning electron microscopy image of the ZnO NRs grown on the flexible substrate without an rGO coating, according to one embodiment of the present disclosure;

FIG. 45 is a scanning electron microscopy image of the ZnO NRs grown on rGO-ITO-PET, further depicting the ZnO NRs growing to ˜60 nm in diameter and ˜1.28 μm in height, according to one embodiment of the present disclosure;

FIG. 46 is an elemental mapping image of the ZnO NRs on rGO-ITO-PET by energy-dispersive X-ray spectroscopy (EDS), further depicting the samples do indeed include zinc, according to one embodiment of the present disclosure;

FIG. 47 is an elemental mapping image of the ZnO NRs on rGO-ITO-PET by energy-dispersive X-ray spectroscopy (EDS), further depicting the samples do indeed include oxygen, according to one embodiment of the present disclosure;

FIG. 48 is a raman spectra of rGO and ZnO NRs grown on the rGO layer, according to one embodiment of the present disclosure;

FIG. 49 is a cyclic voltammogram using 5 mM [Fe(CN)₆]^{-3/-4} in 0.1 M KCl solution at different steps of modification in the range of 10-110 mVs⁻¹ of a bare ITO-PET substrate, according to one embodiment of the present disclosure;

FIG. 50 is a cyclic voltammogram using 5 mM [Fe(CN)₆]^{-3/-4} in 0.1 M KCl solution at different steps of modification in the range of 10-110 mVs⁻¹ of an rGO-ITO-PET substrate, according to one embodiment of the present disclosure;

FIG. 51 is a cyclic voltammogram using 5 mM [Fe(CN)₆]^{-3/-4} in 0.1 M KCl solution at different steps of modification in the range of 10-110 mVs⁻¹ of ZnO NRs-rGO-ITO-PET, according to one embodiment of the present disclosure;

FIG. 52 is a linear calibration plot of redox peak currents versus the square root of the scan rate of a bare ITO-PET substrate, according to one embodiment of the present disclosure;

FIG. 53 is a linear calibration plot of redox peak currents versus the square root of the scan rate of an rGO-ITO-PET substrate, according to one embodiment of the present disclosure;

FIG. 54 is a linear calibration plot of redox peak currents versus the square root of the scan rate of ZnO NRs-rGO-ITO-PET, according to one embodiment of the present disclosure;

FIG. 55 is a bar graph illustrating an electrochemical active surface area (ECSA) of the bare ITO-PET, rGO-ITO-PET, and ZnO NRs-rGO-ITO-PET for the same physical area of 0.15 cm×0.65 cm were estimated to be 0.070 cm², 0.075 cm², and 0.311 cm², respectively, according to one embodiment of the present disclosure;

FIG. 56 is a Nyquist plot of impedance spectra of the electrodes at each step including the bare ITO-PET, rGO-ITO-PET, ZnO NRs-ITO-PET, and ZnO NRs-rGO-ITO-PET, according to one embodiment of the present disclosure;

FIG. 57 is a cyclic voltammogram of the electrodes at each step in 0.1 M PBS containing 200 μM UA, according to one embodiment of the present disclosure;

FIG. 58 is a band diagram illustrating the band structure of the rGO and n-type ZnO as the anode and the UA in the electrolyte before contact, according to one embodiment of the present disclosure;

FIG. 59 is a band diagram illustrating the band structure of the rGO and n-type ZnO as the anode and the UA in the electrolyte during a galvanic condition without strain, further depicting the charge transfer leading to band bending, according to one embodiment of the present disclosure;

FIG. 60 is a band diagram illustrating the band structure of the rGO and n-type ZnO as the anode and the UA in the electrolyte during a galvanic condition with strain, according to one embodiment of the present disclosure;

FIG. 61 is a band diagram illustrating the band structure of the rGO and n-type ZnO as the anode and the UA in the electrolyte during a galvanic condition with strain and anodic bias, according to one embodiment of the present disclosure;

FIG. 62 is a schematic diagram of an experimental setup for evaluating the piezo-electrocatalysis process, further depicting a ZnO-rGO-ITO-PET electrode fixed at a first terminal end at the bottom of the testing beaker and a second terminal end fixed to a distance controller to facilitate the bending curvature of the electrode, thus changing the applied strain, according to one embodiment of the present disclosure;

FIG. 63 is an enlarged view of the testing beaker, as shown in FIG. 62, further depicting a reference electrode, a counter electrode, a working electrode, and the strain being controlled by the distance controller, according to one embodiment of the present disclosure;

FIG. 64 is a schematic diagram illustrating the piezoelectric polarization during the piezo-electrocatalysis process of the ZnO NRs-rGO-ITO-PET electrode, according to one embodiment of the present disclosure;

FIG. 65 is a CV line graph illustrating a CV curve of the ZnO-rGO-ITO-PET electrode in the presence of 50 μM UA in 0.1M PBS before and after bending, further depicting a shift of the oxidation peak (0.330 V to 0.315 V) and the overall current density increase upon bending indicates the piezoelectric effect in the ZnO NRs, according to one embodiment of the present disclosure;

FIG. 66 is a Nyquist plot diagram of the ZnO-rGO-ITO-PET electrode in the presence of 50 μM UA in 0.1M PBS before and after bending, according to one embodiment of the present disclosure;

FIG. 67 (4e) is a line graph illustrating the differential pulse voltammetry (DPV) response of the ZnO NRs-rGO-ITO-PET electrode under −0.9% strain towards 0-200 μM UA, wherein the inset is the linear regression fitting of the DPV peaks, according to one embodiment of the present disclosure;

FIG. 68 (4f) is a line graph illustrating the DPV peaks towards UA upon different applied strains, according to one embodiment of the present disclosure;

FIG. 69 (4g) is a line graph illustrating the sensitivity evolution corresponding to different applied strains, according to one embodiment of the present disclosure;

FIG. 70 is a plot diagram illustrating the sensitivity (μA μM⁻¹ cm⁻²) versus LOD (μM) of the piezoelectric ZnO-rGO-ITO-PET electrode (under −0.9% strain) compared with state-of-the-art flexible electrochemical UA sensors, according to one embodiment of the present disclosure;

FIG. 71 is a Nyquist plot diagram of impedance spectra of the ZnO-ITO-PET electrode, according to one embodiment of the present disclosure;

FIG. 72 is a line graph illustrating the corresponding differential pulse voltammetry response of electrodes at each modification step, according to one embodiment of the present disclosure;

FIG. 73 is a line graph illustrating cyclic voltammograms in 0.1 M PBS containing 200 μM UA of the ZnO NRs-rGO-ITO-PET electrode at scan rates varying through 10-110 mV s⁻¹, according to one embodiment of the present disclosure;

FIG. 74 is a line graph illustrating the linear relationship between oxidation peak current and the square root of the scan rate, according to one embodiment of the present disclosure;

FIG. 75 is a Nyquist plot of impedance spectra of the ITO-PET substrate under a different negative strains, according to one embodiment of the present disclosure;

FIG. 76 is a Nyquist plot of impedance spectra of the ITO-PET substrate under a positive strain, according to one embodiment of the present disclosure;

FIG. 77 is a band diagram illustrating the ZnO NRs under compressive strain during the electrochemical UA sensing process (dashed and solid line for before and after strain, respectively), according to one embodiment of the present disclosure;

FIG. 78 is a line graph illustrating the repeatability of the ZnO-rGO-ITO-PET electrode performance using 25 μM UA in a 0.1M PBS solution, according to one embodiment of the present disclosure;

FIG. 79 is a line graph illustrating the reproducibility of three ZnO-rGO-ITO-PET electrodes performance using 25 μM UA in a 0.1M PBS solution, according to one embodiment of the present disclosure;

FIG. 80 is a line graph illustrating the amperometric response of the ZnO-rGO-ITO-PET electrodes under 0.6% strain at 0.3 V with additions of 5 μM UA at each step and 2 mM different interfering species in 0.1 M PBS solution, according to one embodiment of the present disclosure; and

FIG. 81 is a flow chart illustrating a second method of manufacturing the sensor, according to one embodiment of the present disclosure.

### DETAILED DESCRIPTION

The following description of technology is merely exemplary in nature of the subject matter, manufacture, and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature unless otherwise disclosed, and thus, the order of the steps can be different in various embodiments, including where certain steps can be simultaneously performed.

### I. Definitions

Unless otherwise defined, all technical terms used herein have the same meaning as commonly understood by one of ordinary skill in the art to which the present disclosure pertains.

As used herein, the terms “a” and “an” indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters. In the present disclosure the terms “about” and “around” may allow for a degree of variability in a value or range, for example, within 10%, within 5%, or within 1% of a stated value or of a stated limit of a range. Likewise, in the present disclosure the term “substantially” can allow for a degree of variability in a value or range, for example, within 90%, within 95%, or within 99% of a stated value or of a stated limit of a range.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping, or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below,” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

### II. Description

Piezocatalysis emerges as an effective mechanism to enhance the efficiency of catalytic processes with the strain-induced piezoelectric field. In this case, the chemical species such as pollutants, dyes, drug, and H₂O molecules can thermodynamically undergo reduction or oxidation reactions when being in contact with the piezoelectric materials. The efficiency of a piezocatalysis process can be modulated by engineering the type, size, and morphology of the piezoelectric materials and controlling the mechanical stimuli (e.g., strain, pressure, etc.). Compared to traditional piezoelectric materials that are brittle and insulating, low-dimensional piezoelectric semiconductors such as zinc oxide nanowires and 2D transition-metal-dichalcogenides offer unexplored possibilities for leveraging the coupling of piezoelectricity to various catalytic processes. The superior mechanical properties of these nanostructured piezoelectrics also allow mechanical tunability inaccessible to bulk or thin-film materials, facilitating the efficient piezocatalysis driven by a low mechanical budget. Rationally designed, catalytically active, nanostructured piezoelectric semiconductors hold promise to address the challenges facing the current catalysts for the enhanced sensing of AA through cost-effective electrocatalytic pathways, e.g., with mechanical stimuli.

Advantageously, the electrochemical sensor system may provide a cost-efficient, high-performance piezo-electrocatalytic sensor for detecting AA, with the electrocatalytic efficacy significantly boosted by the piezoelectric polarization charges induced in the nanostructured semiconducting zinc oxide (ZnO) catalyst. Zinc oxide nanorods (ZnO NRs) 104 and nanosheets (NSs 106) 106 were prepared to characterize and compare their efficacy for the piezo-electrocatalysis of AA. The distribution of piezoelectric potential in the nanostructured ZnO catalysts 104, 106 were simulated using the finite element method (FEM). The relationship between the piezoelectric potential and piezocatalytic efficiency was established by elucidating the charge transfer between the strained ZnO nanostructures and AA. In a specific, non-limiting example, the deformed ZnO NRs 104 and NSs 106 possess boosted catalytic efficiency for AA, which increases around 4.72 times and around 0.5 times compared with that of the undeformed ZnO NRs 104 and NSs 106, respectively. With continued reference to the non-limiting example, the fabricated AA sensors exhibited wide actual detection ranges (10 μM-2.9 mM for deformed ZnO NRs 104 and 10 μM-3.4 mM for deformed ZnO NSs 106) and low detection limits (0.48 μM for deformed ZnO NRs 104 and 0.72 μM for deformed ZnO NSs 106, S/N=3), superior to the state-of-the-art AA sensors. It is contemplated the piezo-electrocatalytic process of the present disclosure could utilize the otherwise wasted environmental mechanical energy (e.g., wind energy, wave energy, tidal energy, biomechanical energy, etc.) to boost the electrocatalytic efficiency. The concept of piezo-electrocatalysis can be extended to numerous other catalytic processes of biomedical, pharmaceutical, and agricultural interest. Desirably, the hydrothermal synthesis of ZnO nanostructures also allows the low-cost, scalable production and integration of piezoelectrically-enhanced AA sensors into deformable form factors for wearable sensors capable of real-time and non-invasive monitoring of uric acid, lactate, ascorbic acid, glucose, and caffeine in sweat, where the sensor performance could be boosted by the human-generated mechanical signals.

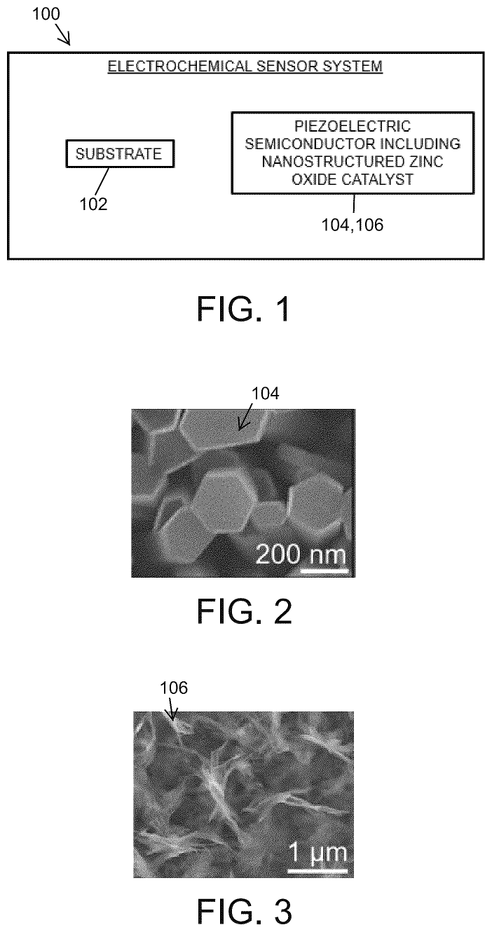

The sensor 100 is configured to detect ascorbic acid using piezo-electrocatalysis. As shown in FIG. 1, the sensor 100 includes a substrate 102 and a piezoelectric semiconductor 104, 106. The piezoelectric semiconductor 104, 106 may be coupled to the substrate 102. In a specific example, the piezoelectric semiconductor 104, 106 may be hydrothermally synthesized to the substrate 102. In a specific example, the piezoelectric semiconductor 104, 106 may include a nanostructured semiconducting ZnO catalyst. In certain circumstances, the nanostructured semiconducting ZnO catalyst 104, 106 may have a noncentrosymmetric wurtzite configuration.

The nanostructured semiconducting ZnO catalyst 104, 106 may be provided in many ways. For instance, the nanostructured semiconducting ZnO catalyst 104, 106 may have a noncentrosymmetric wurtzite configuration. The noncentrosymmetric wurtzite configuration may include a crystal formation with hexagonal symmetry. In a specific example, the nanostructured semiconducting ZnO catalyst 104, 106 may be provided as a ZnO nanorod 104. The ZnO nanorod 104 may have a terminal end 108 connected to the substrate 102. The ZnO nanorod 104 may have a substantially hexagonal cross-section. In another specific, non-limiting example, the nanostructured semiconducting ZnO catalyst 104, 106 may be provided as a ZnO nanosheet 106. A skilled artisan may select other suitable shapes and formations of the ZnO catalyst 104, 106, within the scope of the present disclosure.

In certain circumstances, the substrate 102 may be provided in various ways. For instance, the substrate 102 may be constructed from a conductive material, such as a metal material and/or graphite. In a more specific example, the substrate 102 may include an indium tin oxide substrate. In an even more specific example, the substrate 102 may include an indium tin oxide coated polyethylene terephthalate film. One skilled in the art may select other suitable materials to form the substrate 102, within the scope of the present disclosure.

In certain circumstances, the sensor 100 may be configured with various capabilities and applications. For instance, the sensor 100 may have a limit of detection less than three micromolars. Limit of Detection may be understood as the lowest quantity or concentration of a component that can be reliably detected with a given analytical method. Advantageously, the present disclosure is capable of lower limits of detection compared to known sensors, thereby enhancing the accuracy and fields of application of the sensor 100. As a non-limiting example, the sensor 100 may be provided in a wearable electrocatalytic device. In a specific example, the sensor 100 may also detect uric acid, lactate, glucose, and/or caffeine. In as further non-limiting examples, the sensor 100 may be configured to be utilized in many applications such as biomedical devices, pharmaceutical devices, and agricultural devices.

In one embodiment, the sensor 100 provided as a wearable electrocatalytic device and may further be provided on a flexible substrate. Without being bound to any particular theory, it is believed the wearable electrocatalytic device provided on a flexible substrate may have enhanced sensing capabilities and provide more comfort to a user. More specifically, the nanostructured semiconducting ZnO catalyst 104, 106 may be coupled to an indium tin oxide coated polyethylene terephthalate (ITO-PET) substrate 102. As a non-limiting example, the nanostructured semiconducting ZnO catalyst 104, 106 may be coupled to the ITO-PET substrate 102 via a hydrothermal method. In a more specific example, the semiconducting ZnO catalyst 104, 106 and the ITO-PET substrate 102 may be coated with a drop-casted reduced-graphene-oxide (rGO) coating. Advantageously, where the sensor 100 is provided as a wearable electrocatalytic device provided on a flexible substrate, the mechanical motion of a user may drive a piezoelectrochemical reaction for enhancing the detection of uric acid. Uric acid (2,6,8-trihydroxypurine, UA) is a weak organic acid produced in the human body as the inert end product of purine metabolism. UA acts as a pathophysiological alarm signal to trigger inflammation as the immune response. Variation in UA concentration could be an indication of physiological diseases such as gout, hyperuricemia, and hypertension, as well as an indication of psychological conditions such as anxiety and depression. Desirably, the sensor 100 provided as a wearable electrocatalytic device provided on a flexible substrate may enable non-invasive, real-time monitoring of UA while providing superior limits of detection and sensitivity over current UA monitors.

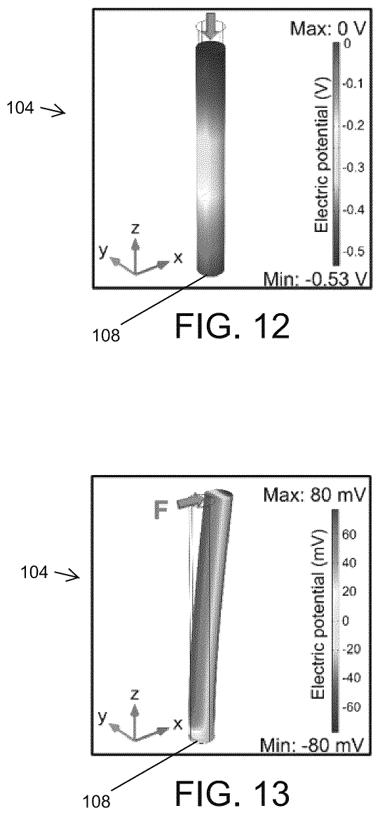

In certain circumstances, the sensor 100 provided as a wearable electrocatalytic device provided on a flexible substrate was tested with a small compressive strain (−0.9%). The sensor 100 showed an almost 4-fold enhancement in UA sensitivity compared to undeformed ones. Provided as a non-limiting example, the sensor 100 exhibited a superior sensitivity of 3.91 μA μM⁻¹ cm⁻² and a Limit of Detection of 0.086 μM, outperforming all known electrochemical UA sensors. In certain circumstances, the nanostructured semiconducting ZnO catalyst 104, 106 may be capable of inducing piezoelectric polarization charges while under mechanical deformations. As a non-limiting example, the mechanical deformation may include an applied force that pushes the ZnO catalyst 104, 106 causing a bending curvature between around 0.2% to around 0.6%. In a specific example, the piezoelectric potential in a nanorod 104 may continuously distribute along a polar axis where an axial compression is applied to the ZnO nanorod 104 with its terminal end 108 mechanically fixed to the substrate 102 and electrically grounded. As shown in FIG. 12, the piezoelectric potential in the nanorod 104 continuously distributes along the polar axis.

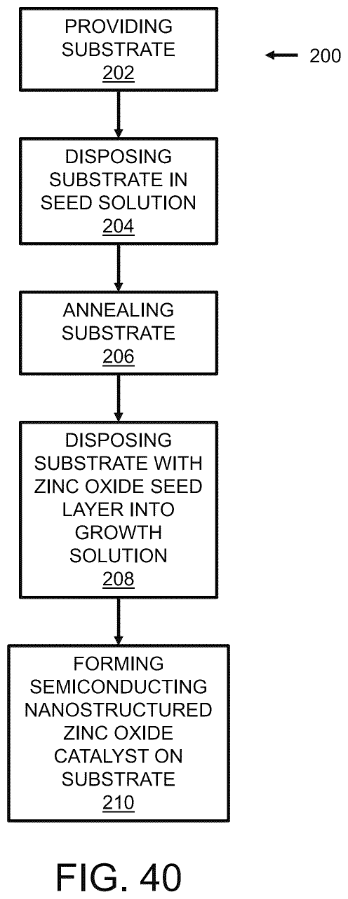

In another embodiment, the present technology includes methods of manufacturing the sensor 100. For instance, as shown in FIG. 40, a method 200 of manufacturing the sensor 100 may include providing a substrate 102. The substrate 102 may be constructed from a conductive material, such as a metal material and/or graphite. In a more specific example, the substrate 102 may include an indium tin oxide substrate. In an even more specific example, the substrate 102 may include an indium tin oxide coated polyethylene terephthalate film. Next, the method 200 may include disposing the substrate 102 in a seed solution. It is also contemplated for the seed solution to be disposed onto the substrate 102. The seed solution may include a zinc salt such as zinc acetate, zinc nitrate, and/or zinc chloride. In a more specific example, the seed solution may include zinc acetate dihydrate. The seed solution may be configured to produce a ZnO seed layer on the substrate 102. In some circumstances, the method 200 may include a step 206 of annealing the substrate 102. In a specific example, the substrate 102 may be annealed at around eight-five degree Celsius. In a more specific example, the substrate 102 may be disposed in the seed solution and annealed multiple times. In an even more specific example, the substrate 102 may undergo a final annealing cycle at around two-hundred fifty degrees Celsius for around twenty minutes. After the substrate 102 is annealed, a ZnO seed layer may be coupled to the substrate 102. Then, the substrate 102 with the ZnO seed layer may be disposed into a growth solution. The growth solution may be configured to form a semiconducting nanostructured ZnO catalyst 104, 106 on the substrate 102. In a specific example, the growth solution may include zinc nitrate and/or hexamethylenetetramine to form ZnO NRs 104. In a separate, specific example, the growth solution may include zinc chloride and potassium chloride to form ZnO NSs 106. Afterwards, a semiconducting nanostructured ZnO catalyst 104, 106 may be formed on the substrate 102, thereby manufacturing the sensor 100.

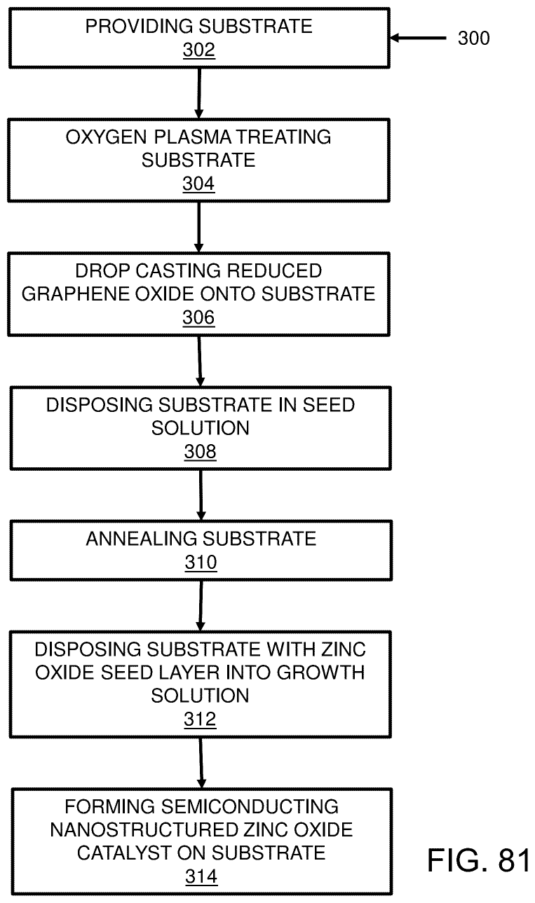

In certain circumstances, the sensor 100 provided as a wearable electrocatalytic device may be provided in various ways. For instance, as shown in FIG. 81, the sensor 100 provided as a wearable electrocatalytic device may be provided according to a second method 300. The second method 300 may include a step of providing a substrate. In a specific example, the substrate may be flexible. In a more specific example, the substrate may be an indium tin oxide coated polyethylene terephthalate (ITO-PET) substrate. In certain circumstances, the substrate may be oxygen plasma treated. In another circumstance, rGO may be drop casted onto the substrate. Next. The substrate may be disposed in a seed solution including zinc, the seed solution configured to produce a zinc oxide seed layer on the substrate. The substrate may then be annealed. Afterwards, the substrate with the zinc oxide seed layer may be disposed into a growth solution. The growth solution may be configured to form a semiconducting nanostructured zinc oxide catalyst on the substrate. Then, a semiconducting nanostructured zinc oxide catalyst may be formed on the substrate.

### III. Example

Provided as a specific, non-limiting example, one embodiment of the ZnO NRs 104 and NSs 106 were synthesized via a hydrothermal method. The hydrothermal method may be understood as the process of crystallizing substances from high-temperature aqueous solutions at high vapor pressures. The morphology control was achieved through the surface selective electrostatic interaction. The growth solutions of the two morphologies consist of different zinc-precursors, namely zinc nitrate and zinc chloride. The introduction of Cl⁻ benefits the growth of nanosheets 106. Without being bound to any particular theory, it is believed the selective adsorption of the highly electronegative Cl⁻ ions on a polar ±(0001) plane may hinder the growth of the ZnO nanostructure along a polar axis [0001] direction.

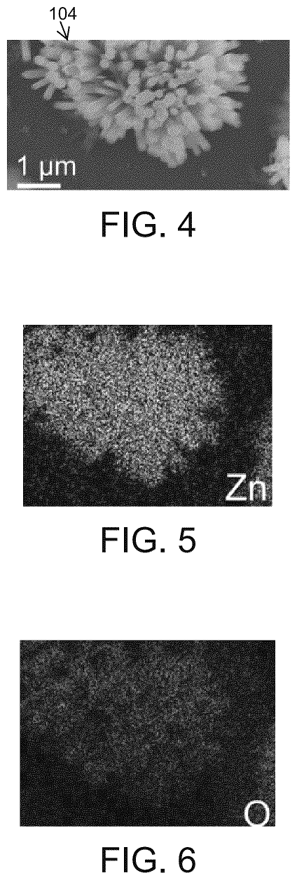

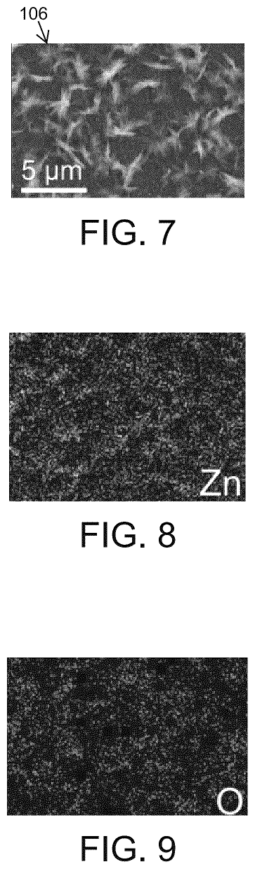

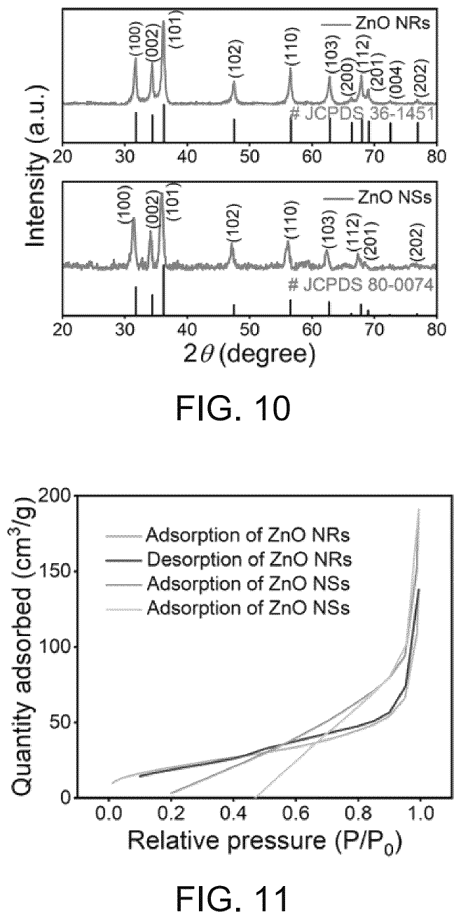

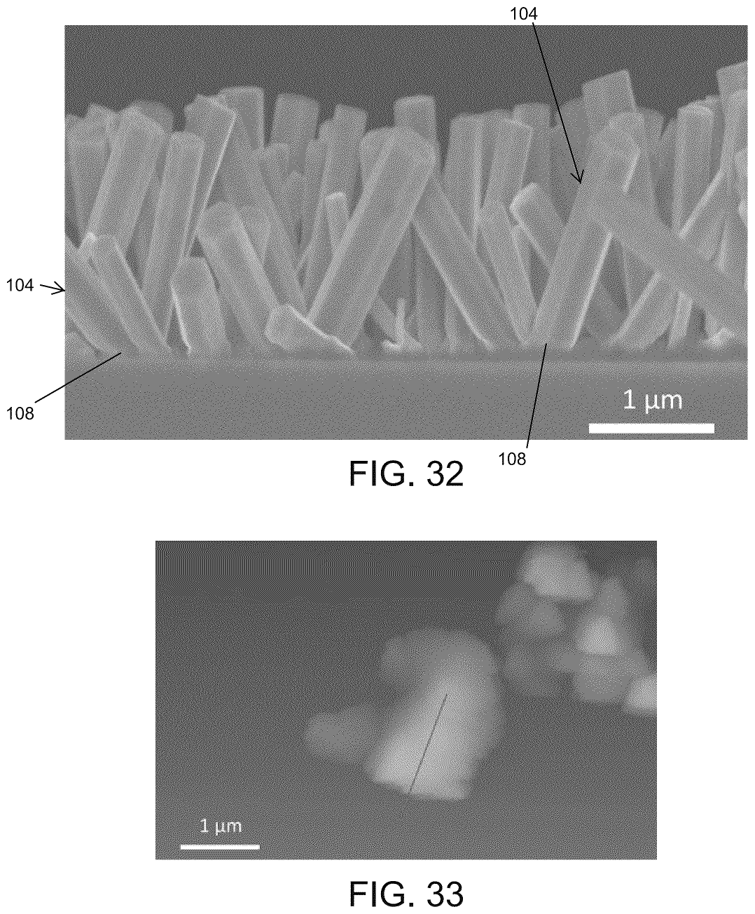

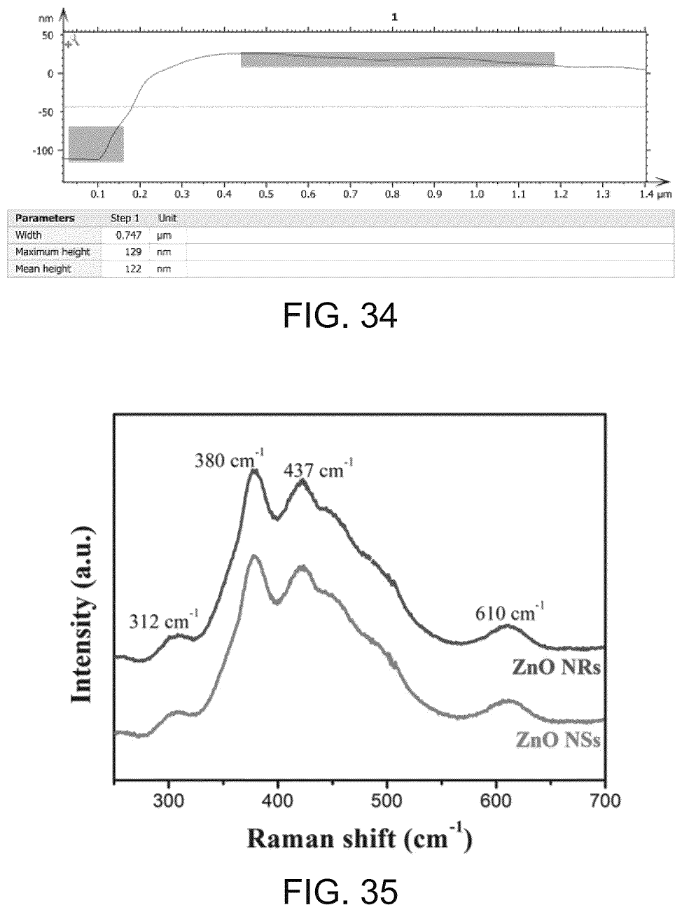

The morphologies of the as-synthesized ZnO NRs 104 and NSs 106 on indium tin oxide (ITO) substrates 102 were examined using scanning electron microscopy (SEM), as shown in FIGS. 2-9 and 32. The obtained ZnO NRs 104 exhibit a homogenous rod-like morphology (with a uniform diameter of ˜200 nm and a length of ˜2 μm) and a hexagonal cross-section typical to the one-dimensional wurtzite ZnO structures. The SEM and atomic force microscope (AFM) characterizations of ZnO NSs 106, as shown in FIGS. 3, 7-9, and 33-34 revealed their 2D morphology, with an average thickness of ˜122 nm and an edge length ˜1-2 μm. The energy-dispersive X-ray spectroscopy (EDS) mapping, as shown in FIGS. 4-9, confirmed that the obtained samples consist of zinc and oxygen elements. The crystal structure and phase purity of the ZnO NRs 104 and NSs 106 were examined with X-ray diffraction (XRD) analysis, as shown in FIG. 10. As a non-limiting reference, the as-synthesized ZnO NRs 104 were identified with the ZnO hexagonal wurtzite structure (JCPDS Card No. 36-1451), and the ZnO NSs 106 were identified with the wurtzite ZnO crystalline phase (JCPDS Card No. 80-0074). The sharp diffraction peaks also indicate good crystallinity of the obtained samples. Raman spectra were also measured to study the lattice vibration of ZnO NRs 104 and NSs 106, as shown in FIG. 35. The peak at 437 cm⁻¹ corresponds to the non-optical phonon E_{2H} mode and is associated with the oxygen sublattice, confirming the wurtzite structure of both the ZnO NRs 104 and NSs 106. No other impurity peaks appeared in the XRD and Raman spectra, indicating the formation of pure phase materials.

The specific surface area of the obtained ZnO nanomaterials were characterized by N₂ adsorption-desorption analysis, as shown in FIG. 11. According to the Brunauer-Emmett-Teller (BET) model, the specific surface area of ZnO NRs 104 can be determined as 75.8 m² g⁻¹, which is approximately 4.6 times higher than that of ZnO NSs 106 (13.6 m² g⁻¹). Such a difference in the specific surface area can be understood because NRs 104 extend more in the z-axis and are densely arranged, resulting in more exposed surfaces. The nanorods 104 with a high surface area provide a larger amount of accessible reactive sites for the piezocatalysis of AA, facilitating the adsorption and desorption of AA and facilitate the efficient electric charge transfer between the catalyst and reactant.

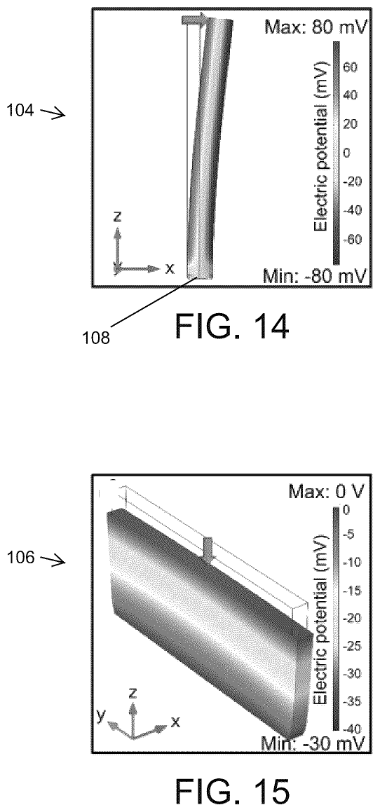

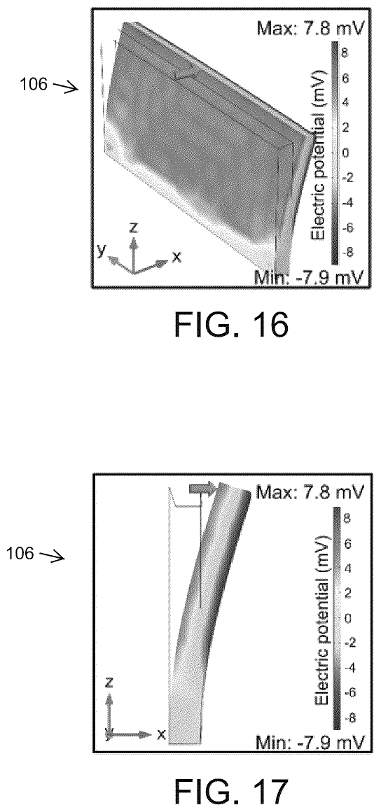

ZnO with a noncentrosymmetric wurtzite structure can induce piezoelectric polarization charges on the surface under mechanical deformations. A finite element calculation was performed to simulate the distribution of piezoelectric potential produced in the ZnO NRs 104 and NSs 106, as shown in FIGS. 12-17. In all simulations, the polar axis (i.e., [0001]) of the ZnO NRs 104 were oriented along the z-axis. As shown in FIG. 12, the FEM simulation results for the case when an axial compression was applied to a ZnO nanorod 104 with the terminal end 108 mechanically fixed to the substrate 102 and electrically grounded. The simulation indicates that the piezoelectric potential in the nanorod 104 continuously distributes along the polar axis. As shown in FIGS. 13-14 and 16-17, both the ZnO NRs 104 and NSs 106 can be facilely deformed when a lateral force was applied along the upper surface of the material. In particular, a positive potential is generated on the stretched side of the nanorod 104, and a negative potential is generated on the compressed side of the nanorod 104. The dimension values measured from the material characterization in the FEM simulation were inputted. For ZnO NRs 104 with a diameter (D)=200 nm, length (L)=2 μm, and force (F)=80 nN, FEM simulation shows that the maximum piezoelectric potential generated is 160 mV, as shown in FIGS. 13-14. For ZnO NSs 106 with L=2 m, width=122 nm, height=1 m, and F=80 nN, the induced piezoelectric potential is 15.7 mV. The difference between the induced piezoelectric potential in ZnO NRs 104 and NSs 106 may be understood by the different aspect ratios for these two morphologies, which leads to significantly different deformation behaviors. Because a single nanorod 104 has a larger aspect ratio (length/diameter, ca. 10:1) and a smaller ground contact area than nanosheet 106, it can be easily deformed. Without being bound to any particular theory, it is believed that a higher piezoelectric potential will result in a more efficient catalytic process.

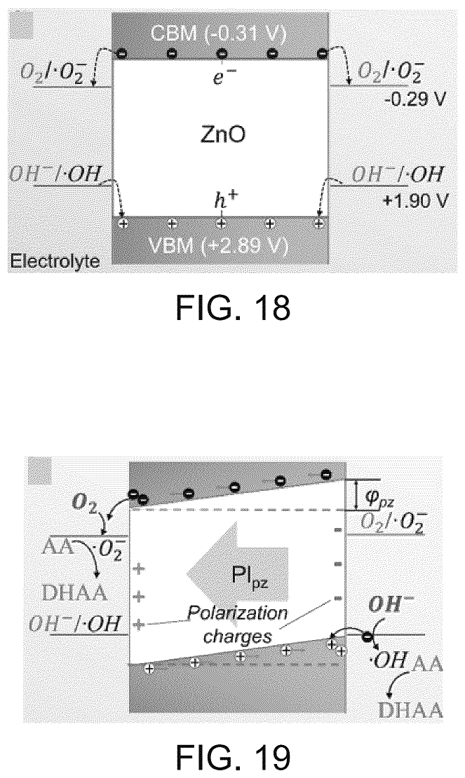

The working mechanism of the piezo-electrocatalysis was further explored by examining the related band diagram, as shown in FIGS. 18-19. The standard redox potential of O₂/·O₂⁻ (−0.29 V) is more positive than the conduction band minimum (CBM) (−0.31 V) of ZnO, as shown in FIG. 18, thus allowing the reduction of dissolved O₂ by the conduction band (CB) electrons from ZnO to produce ·O₂⁻ radicals. Meanwhile, the standard redox potential of OH⁻/·OH (+1.90 V) is more negative than the valence band maximum (VBM) of ZnO (+2.89 V), resulting in the transport of holes to the electrolyte and, therefore, the oxidation of OH⁻ to ·OH radicals. When an external force is applied, the induced piezoelectric polarization charges on the surfaces of ZnO NRs 104 and NSs 106 couple with the electrical excitation in impacting the redox processes that occur on the ZnO surfaces. As illustrated in FIG. 19, the band tilting in ZnO with the piezoelectric potential further promotes the above two redox processes for O₂ and OH⁻ at the respective surfaces. Such an enhanced redox process occurs in ZnO NRs 104 and NSs 106 independent of the direction of the applied forces. The relatively larger piezoelectric potential in ZnO NRs 104 may lead to a more efficient generation of the ·O₂⁻ and ·OH radicals, exhibiting improved catalytic performance. Electrons in the conduction band can react with oxygen to create superoxide radicals (·O₂⁻), meanwhile, the holes generated at the top of the valance band are energetically favorable for the production of oxidative hydroxyl radicals (·OH). The redox process of AA on the ZnO electrode surface is shown below.

$$ZnO \frac{Electrical - excitation}{Piezoelectric effect} ZnO ( {h}^{+} + {e}^{-} ) \qquad ( 1 )$$

$${OH}^{-} + {h}^{+} ⟶ \cdot OH \qquad ( 2 )$$

$${O}_{2} + {e}^{-} ⟶ \cdot {O}_{2}^{-} \qquad ( 3 )$$

$$\cdot OH ( \cdot {O}_{2}^{-} ) + AA ( {C}_{6} {H}_{8} {O}_{6} ) ⟶ DHAA ( {C}_{6} {H}_{6} {O}_{6} ) \qquad ( 4 )$$

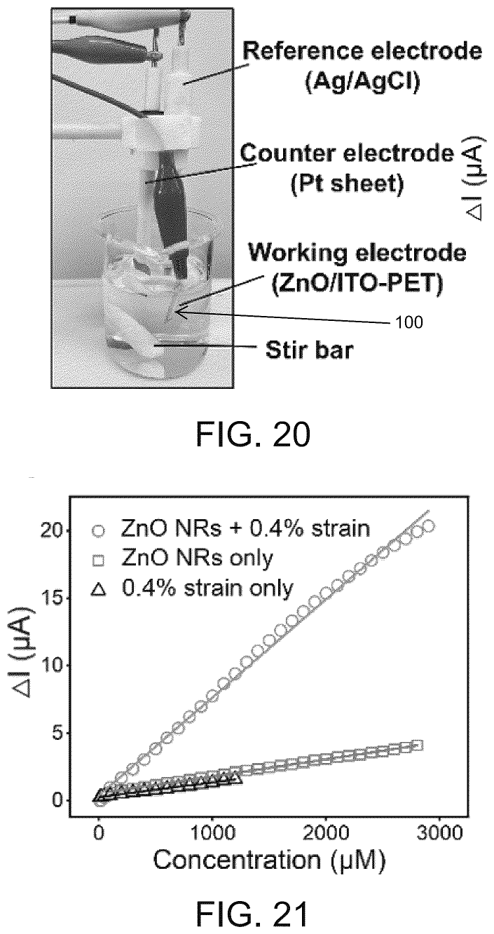

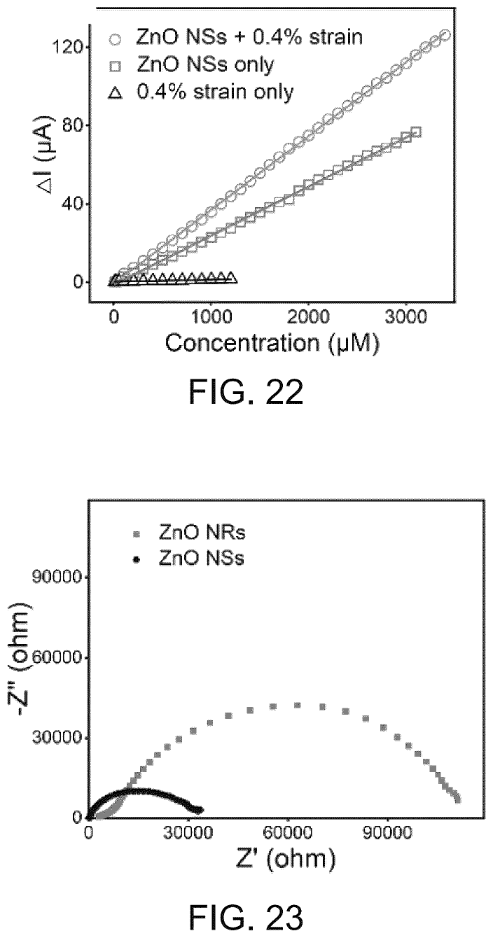

FIG. 20 illustrates the experimental setup for characterizing the piezo-electrocatalysis of AA. ZnO nanomaterials were hydrothermally synthesized on the ITO-PET substrate 102. The applied strain was controlled by modulating the bending curvature of the substrate 102. The catalytic efficiency of different electrodes was characterized by recording the catalytic currents for different concentrations of AA. The impact of the piezoelectric effect on the electrocatalytic sensing of AA was investigated under three different experimental conditions: undeformed ZnO nanostructures, deformed bare ITO-PET substrates 102, and deformed ZnO nanostructures on ITO-PET substrates 102, as shown in FIGS. 21-22. The experimental results show that under different experimental conditions, the current change (ΔI) increases with the increase of the AA concentration, indicating that these conditions can cause AA to be catalyzed. As shown in FIG. 21, the catalytical performance was enhanced only when both the substrate deformation and piezoelectric material exist simultaneously, indicated by open circles in FIG. 21. In contrast, the electrocatalysis of AA in the absence of either ZnO NRs 104 or deformation was almost negligible. The catalysis capability of undeformed ZnO NRs 104, indicated by open squares in FIG. 21, is attributed to the electrocatalytic property of semiconducting ZnO. The catalytic performance of deformed ZnO with 0.4% tensile strain is due to the combined electrocatalysis and piezocatalysis.

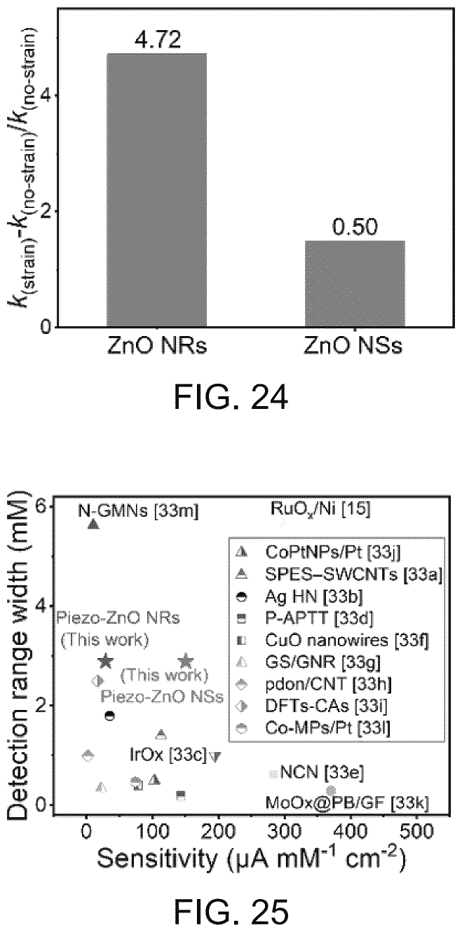

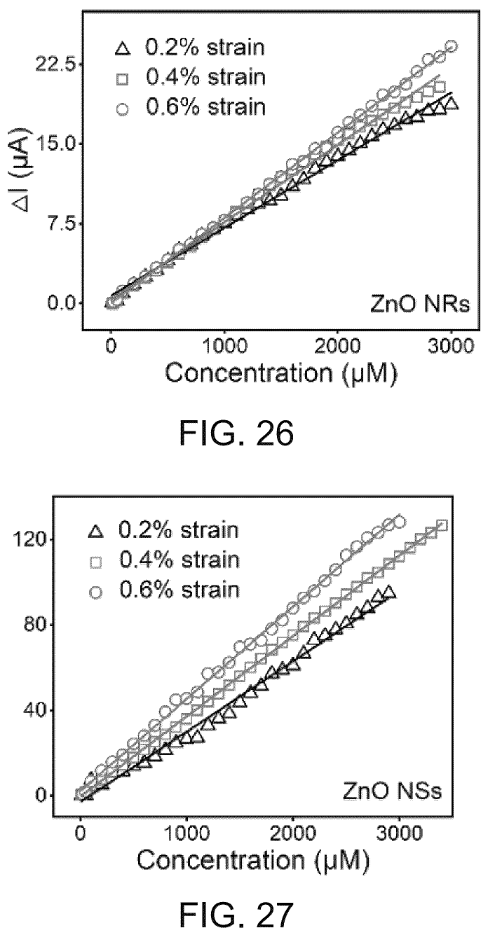

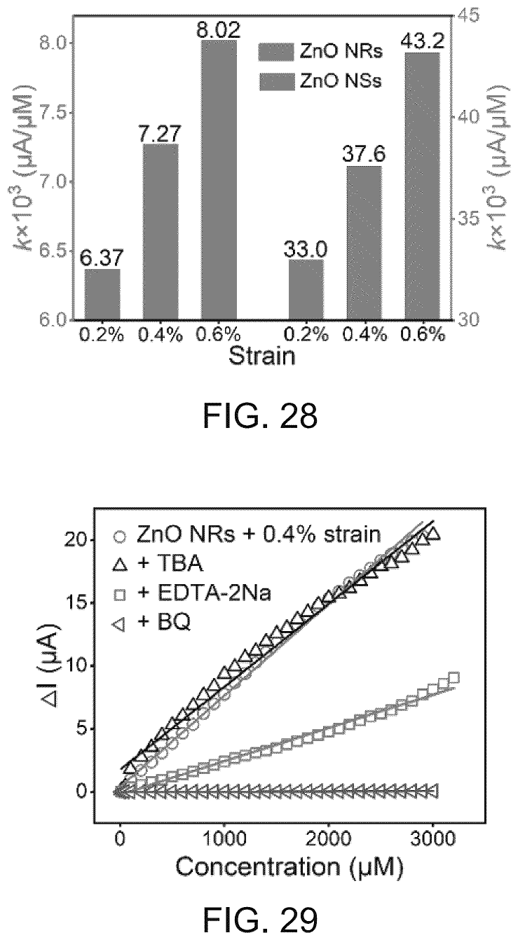

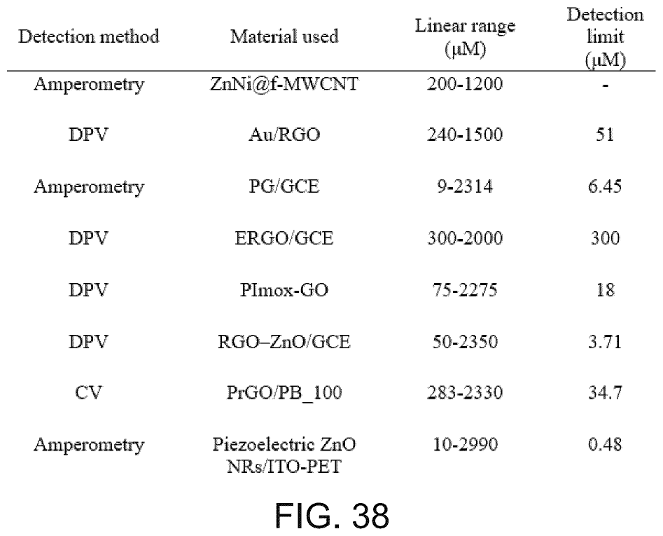

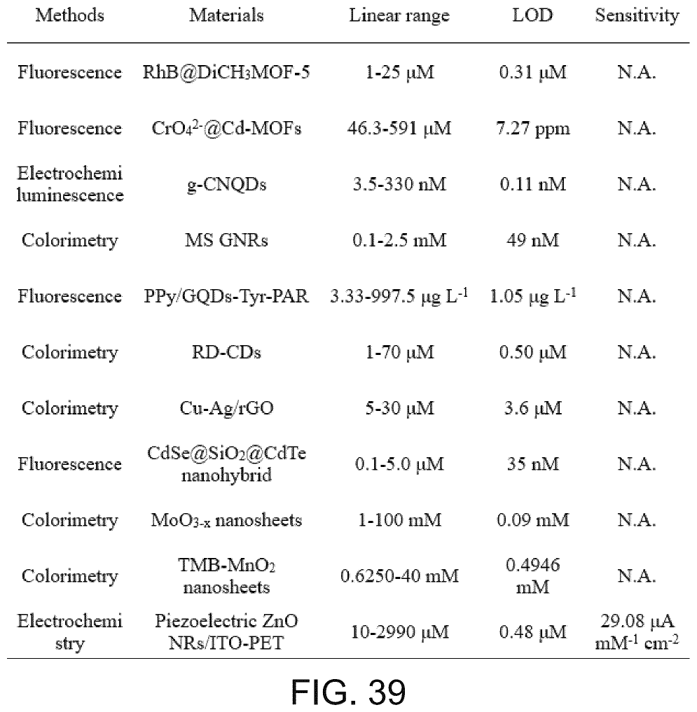

With continued reference to FIGS. 21-22, the reaction kinetics for the piezo-electrocatalysis of AA can be expressed as a linear correlation between ΔI and the AA concentration (C). The corresponding regression, detection range, and limit of detection (LOD) for different AA catalysts are compared in Table 1 on the following page. The LOD of deformed ZnO NRs 104 is calculated as 0.48 μM (S/N=3) and is lower than many known electrocatalysis sensors for AA, as shown in FIG. 38. At the same time, compared with other reported detection methods, piezoelectric ZnO nanomaterials also show comparable detection performance, as shown in FIG. 39. The kinetic rate constant k for the process in 0.4% deformed ZnO NRs 104 increases by 4.72 times compared to that for the undeformed ZnO NRs 104 (from 0.00127 to 0.00727 μA μM⁻¹), as shown in FIG. 21. Meanwhile, the undeformed ZnO NSs 106 have a relatively high background current due to the much lower charge transfer resistance (R_{ct}), as shown in FIG. 23. The kinetic rate constant k for the process in the deformed ZnO NSs 106 increases by 0.5 times compared to that for the undeformed ZnO NSs 106 (from 0.0251 to 0.0376 μA M⁻¹), as shown in FIG. 22. The strain-induced enhancement in the electrocatalytic sensing of AA can be determined by (k₍ₛₜᵣₐᵢₙ₎−k_{(strain-free)})/k_{(strain-free)}, where the kinetic rate constant k (μA μM⁻¹) is the slope of the current change-concentration (ΔI-C) plot. The strain-induced enhancement factors for both ZnO NRs 104 and NSs 106 are shown in FIG. 24. The detection range and sensitivity (μA mM⁻¹ cm⁻²) of the ZnO piezo-electrocatalysts were compared to known AA catalysts, as shown in FIG. 25. The piezo-electrocatalytic sensing of AA exhibits good overall performance compared to the state-of-the-art, as illustrated in FIG. 25. Known catalysts that have competitive performance metrics (e.g., RuOₓ/Ni) are also known to face challenges such as expensive raw materials and complex preparation processes. Compared to ZnO NSs 106, ZnO NRs 104 present more significant piezoelectric enhancement in the electrocatalytic sensing of AA, consistent with our simulation results, as shown in FIGS. 12-17. The piezo-electrocatalytic sensing of AA with ZnO NRs 104 also show more appealing figures of merit, e.g., lower LOD, and comparable sensitivity and detection range, as shown in FIG. 25 and Table 1 below, compared to ZnO NSs 106. It should be appreciated, that the sensing processes (with and without strains) with ZnO NSs 106 show higher ΔI values than ZnO NRs 104, as shown in FIGS. 21-22, which is because the higher conductivity of ZnO NSs 106, as shown in FIG. 23, can accelerate the oxidation reaction of AA on the surface of the material. We further characterized the piezo-electrocatalytic process in ZnO NRs 104 and NSs 106 based electrodes under different strains, as shown in FIGS. 26-27. The rate constant k increased as the strain increased, as shown in FIG. 28. The relationship between the rate constant and the strains indicates that a more significant piezoelectric effect induced by larger strains induced more significant catalytic enhancement.

TABLE 1
Regression, detection range, and limit of detection of different catalyst

| | | | LOD |
|---|---|---|---|
| Catalyst | Linear regression | Detection range | (S/N = 3) |
| ZnO NRs + strain | ΔI (μA) = 0.00727 C + 0.366 (R² = 0.9957) | 10 μM-2.9 mM | 0.48 μM |
| ZnQ NRs only | ΔI (μA) = 0.00127 C + 0.525 (R² = 0.9988) | 10 μM-2.8 mM | 2.76 μM |
| ZnO NSs + strain | ΔI (μA) = 0.0376 C − 0.492 (R² = 0.9997) | 10 μM-3.4 mM | 0.72 μM |
| ZnQ NSs only | ΔI (μA) = 0.0251 C − 1.11 (R² = 0.9989) | 10 μM-3.1 mM | 1.13 μM |
| Strain only | ΔI (μA) = 0.0011 C + 0.248 (R² = 0.9965) | — | — |

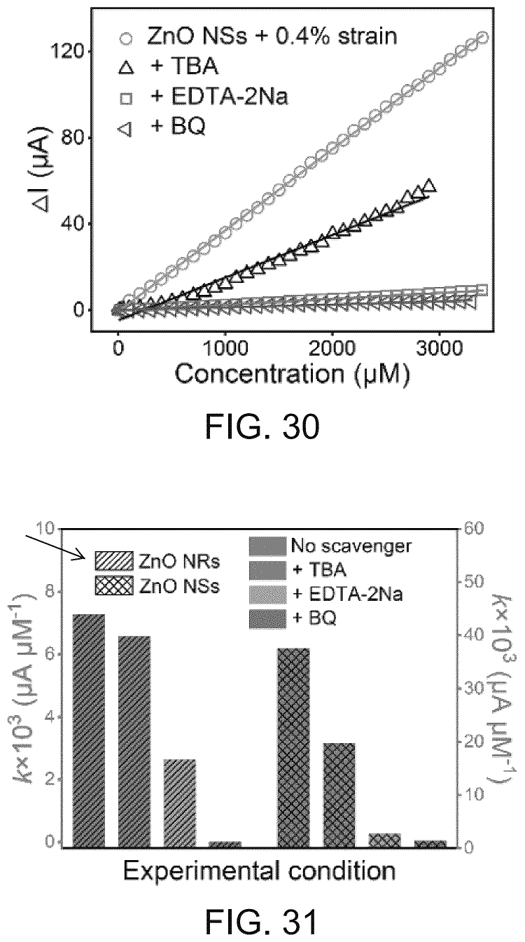

A series of radical trapping experiments were performed using various radical scavengers to identify the role of the radical species and elucidate the fundamental processes involved in the piezo-electrocatalytic sensing of AA. To this end, benzoquinone (BQ), tert-butyl alcohol (TBA), and disodium ethylene diamine tetraacetate dehydrates (EDTA-2Na) were used to scavenge superoxide radicals (·O₂⁻), hydroxyl (·OH), and holes (h⁺), respectively. It is believed that these radicals are induced by the piezoelectric effect. FIGS. 29-30 show the ΔI-C plots for 0.4% strained ZnO NRs 104 and NSs 106 with these radical scavengers. The rate constants for these processes are listed in FIG. 31. The catalytical efficiency of ZnO NRs 104 was remarkably suppressed by BQ (·O₂⁻ scavenger) and EDTA-2Na (h⁺ scavenger), which decreased by 99.73% and 63.69%, respectively. With the addition of ·OH radical scavenger of TBA (·OH scavenger), the catalytical ratio of AA was slightly reduced by 9.49%, illustrating that ·O₂⁻ radicals and holes are the main active species in the piezo-electrocatalytic process. These scavengers also show a similar inhibitory effect on the ZnO NSs 106-based piezo-electrocatalytic activity, as shown in FIGS. 30-31. After adding these inhibitors (TBA, EDTA-2Na, BQ), the catalytic efficiency for AA was reduced by 47.45%, 92.69% and 96.25%, respectively, for ZnO NSs 106. These results indicate that the piezoelectric effect leads to the generation of ·OH, ·O₂⁻ radicals and holes in situ on the surface of both ZnO NRs 104 and NSs 106, which will further react with AA molecules to accelerate the catalytical process (Equations 1-4).

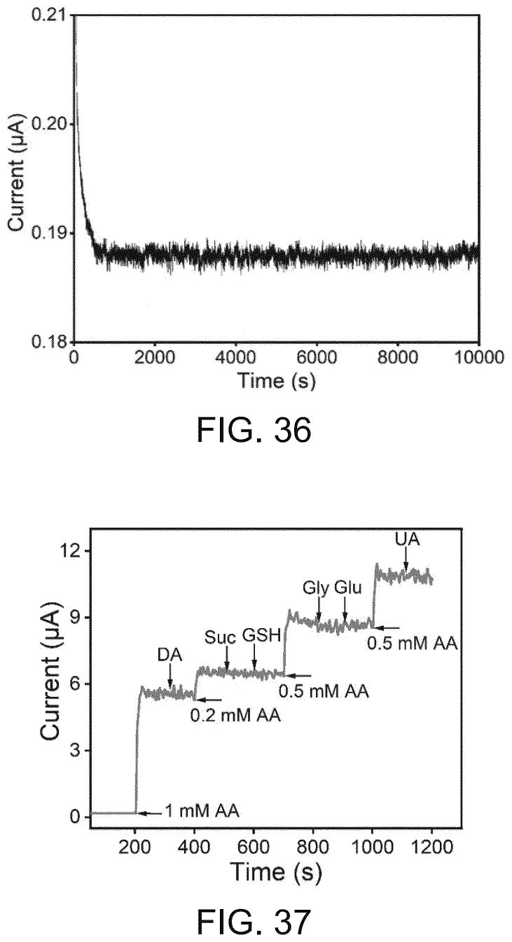

In addition to the catalytic activity, catalytic stability is another critical factor in evaluating reliable electrocatalysts for AA detection. In order to measure the material tolerance and long-term catalytical stability of the ZnO catalysts 104, 106 in the AA detection environment, chronoamperometric measurements were performed for deformed ZnO NRs 104 in 0.01 M NaOH solution at 0.4 V vs. Ag/AgCl for a duration of 10,000 s. The result shows no observable degradation in the piezo-electrocatalytic performance of ZnO NRs 104 after over one and half hours, as shown in FIG. 36. An anti-interference experiment was performed by adding different concentrations of AA and 2.0 mM interfering substances (dopamine (DA), Suc (sucrose), GSH (glutathione), Gly (glycine), Glu (glucose), UA (uric acid)) in a buffer solution sequentially. The result shows that the sensor 100 of present disclosure may only have a significant current response to AA, showing excellent anti-interference performance, as shown in FIG. 37.

Advantageously, the sensor 100 may provide a cost-efficient, high-performance piezo-electrocatalytic sensor for detecting AA, with the electrocatalytic efficacy significantly boosted by the piezoelectric polarization charges induced in the nanostructured semiconducting zinc oxide (ZnO) catalyst 104, 106.

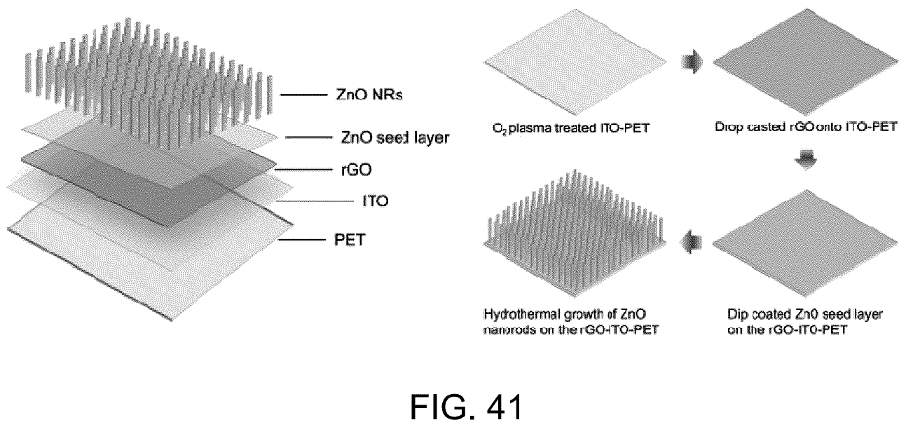

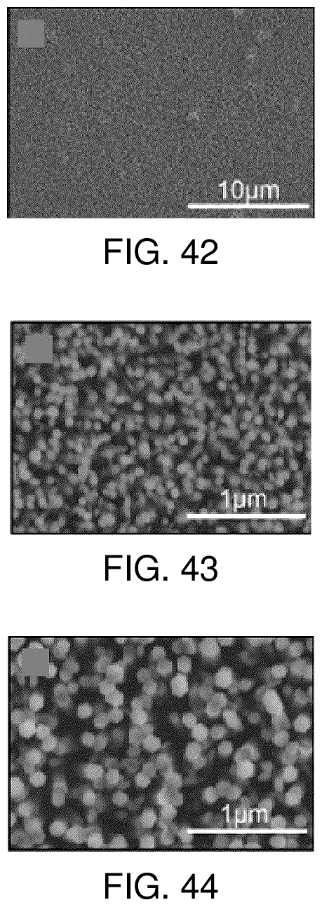

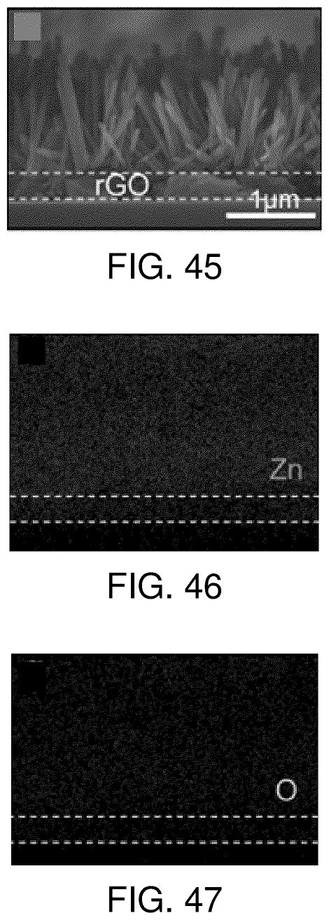

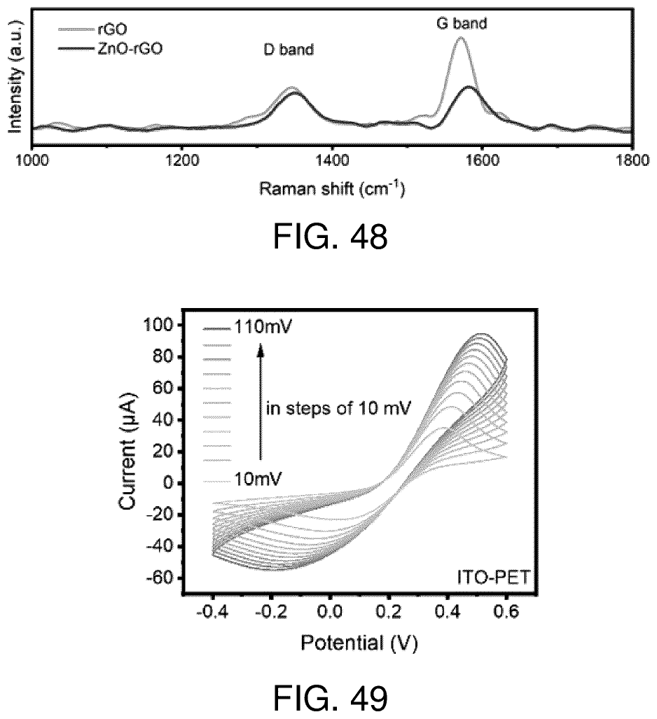

Turning now to the embodiment where the sensor 100 is provided as a wearable electrocatalytic device and may further be provided on a flexible substrate. ZnO NRs were synthesized on rGO-coated flexible ITO-PET substrates using a hydrothermal method. A schematic of the structure and fabrication process of the sensor 100 is shown in FIG. 41. A predetermined amount of rGO was drop-casted on the ITO surface, followed by the hydrothermal synthesis of ZnO NRs. As shown in FIGS. 42-43, a series of scanning electron microscopy (SEM) images of ZnO NRs grown on the rGO-coated ITO-PET. ZnO NRs grown on ITO-PET without rGO coating are shown in FIG. 44. The surfaces of the ITO-PET and the rGO-ITO-PET substrates were fully covered by uniformly grown ZnO NRs with hexagonal cross-sections typical of 1D wurtzite ZnO. Provided as a non-limiting example, the ZnO nanorods grown on rGO-ITO-PET are ˜60 nm in diameter and ˜1.28 μm in height, as shown in FIG. 45, while those grown on ITO-PET were ˜106 nm and ˜1.16 μm in diameter and height, respectively. The incorporation of the rGO layer increased the aspect ratio of the as-synthesized ZnO NRs from ˜11 to ˜21, resulting in enhanced piezoelectric performance. In a specific example. The aspect ratio of the piezoelectric semiconductor may be at least 15 by incorporating the rGO layer. Such an increased aspect ratio could be attributed to the enhanced hydrophilicity of rGO-functionalized ITO-PET compared with bare ITO-PET substrates. The enhanced hydrophilicity of the substrate, together with the similar hexagonal atomic configuration between the c plane of ZnO NRs and the basal plane of rGO, promotes the heteroepitaxial nucleation of ZnO NRs on rGO-ITO-PET. Thus, the increased ZnO seed density resulted in a reduced nanorods' diameter and an almost doubled aspect ratio. The elemental mapping by energy-dispersive X-ray spectroscopy (EDS), as shown in FIGS. 46-47 confirmed that the obtained samples consist of Zn and O elements. Raman spectra were utilized to verify the signature lattice vibration of rGO and ZnO-rGO at room temperature, as shown in FIG. 48. Both samples demonstrated D and G structural bands for carbon, suggesting the existence of rGO. The D band around 1346 cm⁻¹ is associated with the defects in the hexagonal graphitic layers, and the G band around 1571 cm⁻¹ is related to the Raman-active E_{2g} mode with the presence of sp² carbon structures. The intensity ratio of the D band over the G band increased from 0.46 to 0.86 after the growth of ZnO NRs, indicating an enhanced formation of sp² domains, an increased defect density, and the removal of oxygen functional groups. These features suggest a further reduction of rGO after the hydrothermal synthesis of ZnO NRs. In addition, the G band showed a blue shift of 11.1 cm⁻¹ compared to the original rGO, suggesting a further reduction of rGO. Consequently, the conductivity of rGO was enhanced, further promoting the charge transfer between ZnO NRs and rGO, as well as between rGO and the ITO-PET substrate. Such enhanced charge transfer benefits the overall catalytic sensing performance of the sensor 100.

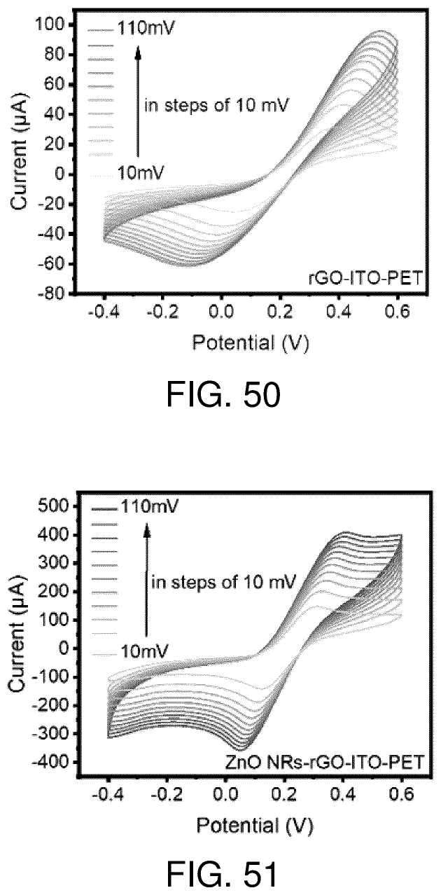

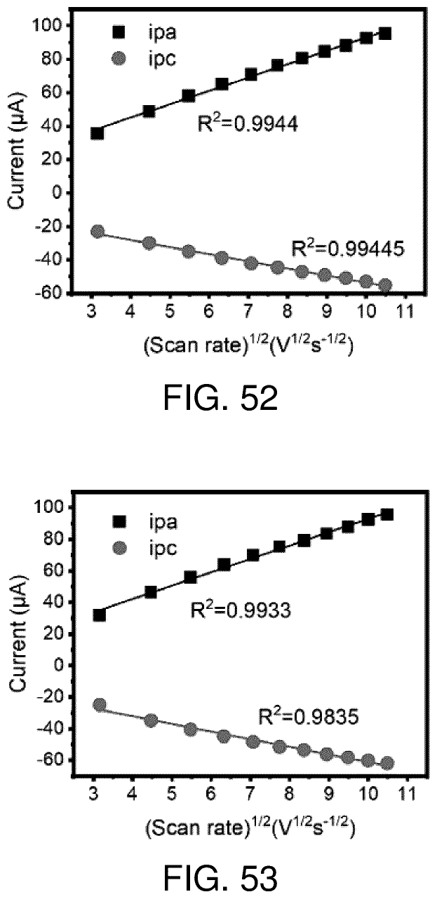

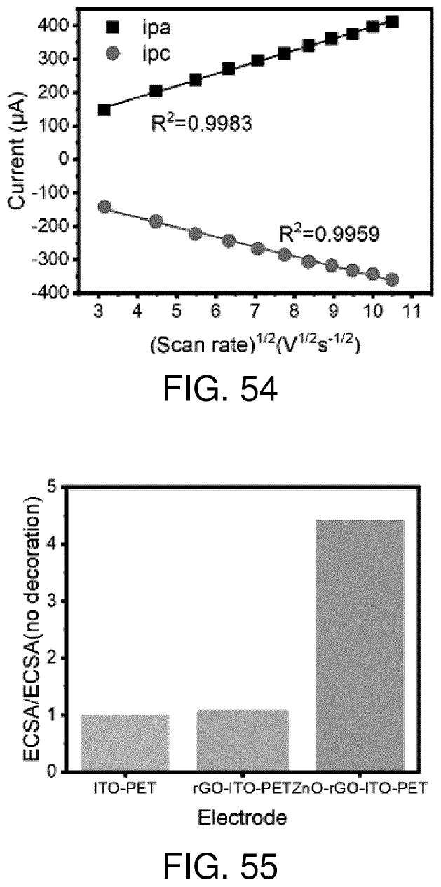

The electroactive surface areas of the sensor 100 was evaluated by performing cyclic voltammetry (CV) measurement, using 5 mM [Fe(CN)₆]^{-3/-4} as the redox probe in 0.1 M KCl solution at each step under various scan rates. As shown in FIGS. 49-51, the recorded CV responses of bare ITO-PET, rGO-ITO-PET, and ZnO-rGO-ITO-PET in the ferricyanide system with the stepwise scan rates in the range of 10-110 mVs⁻¹. Both bare ITO-PET and rGO-ITO-PET generated weak redox peaks at relatively large potentials (i.e., 0.5 to 0.6V and 0 to −0.2V). On the other hand, ZnO NRs on rGO-ITO-PET demonstrated strong and well-defined redox peaks and closer peak-to-peak potentials (0.3 to 0.4V and 0 to 0.1V), indicating significantly improved electrocatalytic activity. As shown in FIGS. 52-54, the linear calibration plots of redox peak currents versus the square root of the scan rate. The electrochemical surface areas of the electrodes were calculated according to the Randles Sevcik formula as follows:

Iₚ=2.69×10⁵n^{3/2}ACD^{1/2}V^{1/2}

where the peak current is denoted by Iₚ (Iₚₐ for anodic and I_{pc} for cathodic), the number of transferred electrons by n, the electroactive area (cm2) by A, the concentration of [Fe(CN)₆]^{-3/-4} molecules (mol/L) by C, the diffusion coefficient of [Fe(CN)₆]^{-3/-4} in solution (cm²s⁻¹) by D, and the scan rate (m/s) by v. The electrochemical active surface area (ECSA) of the bare ITO-PET, rGO-ITO-PET, and ZnO NRs-rGO-ITO-PET for the same physical area of 0.15 cm×0.65 cm were estimated to be 0.070 cm², 0.075 cm², and 0.311 cm², respectively, as shown in FIG. 55. The ECSA of the ZnO NRs-rGO-ITO-PET was improved by 4.15 and 4.44 times compared to rGO-ITO-PET and ITO-PET, respectively, which could be attributed to the high surface area of ZnO NRs with plenty of electrochemically active sites.

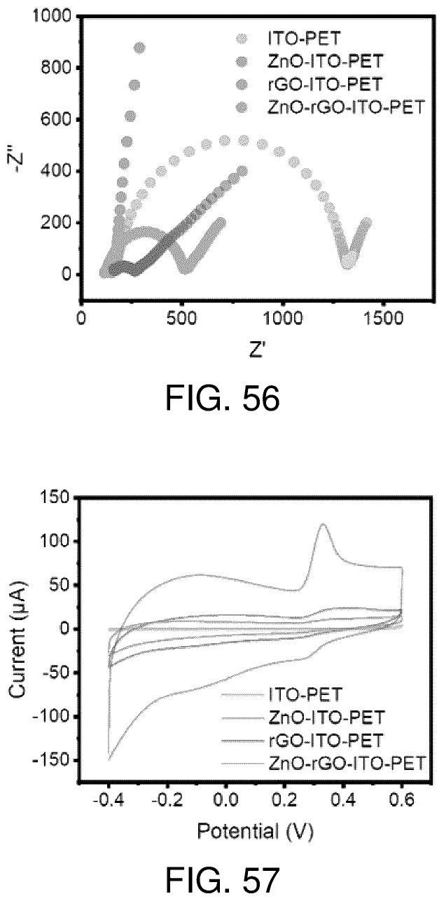

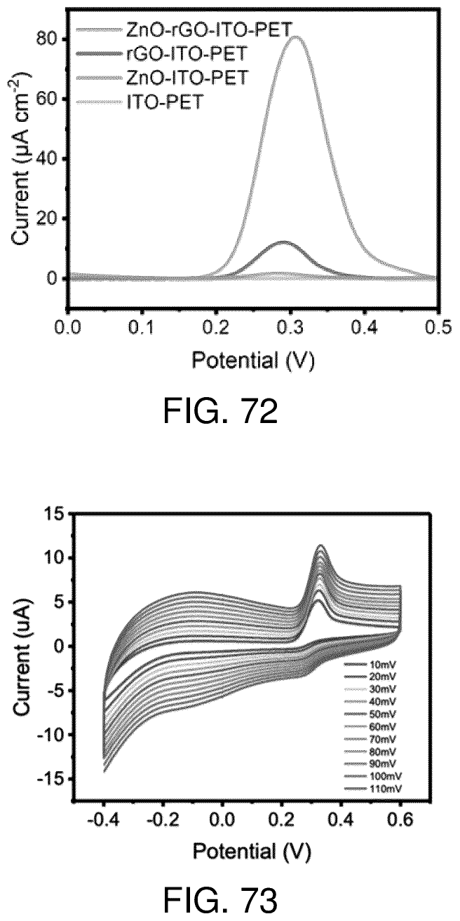

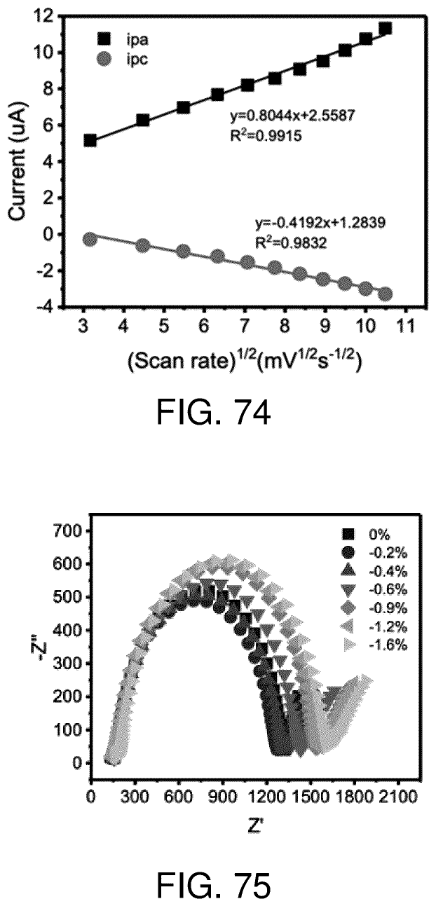

The interfacial electron transfer and the impedance change of the electrodes under each step of modification (i.e., ITO-PET only, rGO-coated ITO-PET, ZnO NRs grown ITO-PET, and ZnO NRs grown on rGO coated ITO-PET) were studied by electrochemical impedance spectroscopy. The charge transfer resistance, represented by the semicircle diameters in the Nyquist plot, as shown in FIGS. 56 and 71, demonstrate an apparent decrease under each modification. At the same time, growing ZnO NRs directly on the ITO-PET would yield substantial transfer resistance due to ZnO's limited electron transfer capability as an n-type semiconductor. The resulting significantly improved charge transfer efficiency of the ZnO NRs-rGO-ITO-PET was believed to result from the rGO layer between ZnO and ITO, which promoted the ZnO growth the interfacial charge transfer between ZnO and rGO. The significantly enhanced ECSA and electron transfer kinetics from ZnO NRs grown on rGO-coated ITO-PETs lead to the noticeable improvement of electrocatalytic activity towards UA sensing, as shown in FIGS. 57 and 72. We further performed CV measurements for the ZnO NRs-rGO-ITO-PET electrode WE at scan rates varying through 10-110 mV s⁻¹ towards 200 μM UA, as shown in FIG. 73. The linear relationship between the oxidation peak current and the square root of the scan rate, as shown in FIG. 74 indicates that the electrochemical reactions of UA molecules at the electrode surface were diffusion controlled.

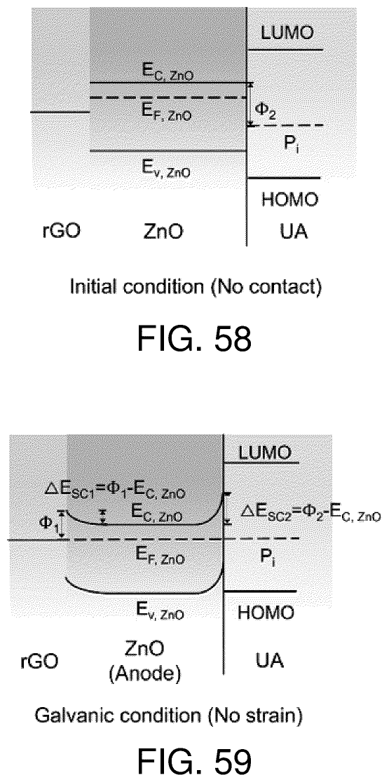

The enhancing mechanism of the electrochemical sensing process by piezoelectricity is illustrated in FIGS. 58-61. The principle of piezo-electrocatalysis is to modulate electrochemical reaction kinetics by tuning the interface between the electrode (e.g., ZnO) and target molecules (e.g., UA) with piezoelectric polarization charges. The essential difference between piezo-electrocatalysis and previously reported piezo-catalysis is the location of the reactions' sites and the piezoelectric materials' role in the catalytic process. During the piezo-electrocatalytic process, oxidation and reduction occur at the anode and cathode (in our case, piezoelectric ZnO NRs act as the anode to oxidize UA), respectively. While during the conventional piezo-catalytical process, the redox reactions happen simultaneously on the piezo-catalysts' surface without separating the anode and cathode. FIG. 58 depicts the band structure of the rGO and n-type ZnO as the anode and the UA in the electrolyte before contact.

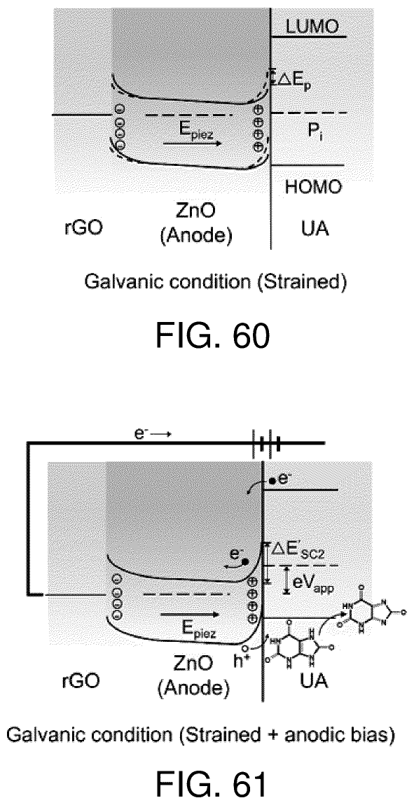

After the galvanic contact is established between the ZnO and the electrolyte as well as between the ZnO and the substrate, the electrons transfer from the material with a low work function (n-type ZnO) to the materials with a high work function (UA and rGO) until reaching the equilibrium, forming a space charge (SC) region with a built-in electric field (ΔE_{SC1}=Φ₁−E_{C,ZnO}, ΔE_{SC2}=Φ₂−E_{C,ZnO}, SC1 refers to space charge region in ZnO at the interface between ZnO and rGO, and SC2 indicates the space charge region between ZnO and electrolyte, respectively) at the ZnO surface. This charge transfer leads to band bending, as shown in FIG. 59. When the electrode is bent inward, a tensile strain is induced along the c-axis direction of ZnO NRs, creating a polarization of cations and anions in the ZnO NRs, as shown in FIG. 60. Such internal piezoelectric field results in an asymmetric effect on the changes of the built-in electric field, with the built-in electric field at the ZnO NRs/electrolyte interface reduced from ΔE_{SC2} to ΔE′_{SC2}=ΔE_{SC2}−ΔEₚ where the ΔEₚ represents the potential change due to local piezopotential as a function of applied strain. Such a polarization also results in the CV peak shift shown in FIG. 60 that will be discussed later. When an anodic bias is applied, the electrons transfer from the LUMO of UA to the conduction band of strained ZnO, thus increasing the electrochemical current as well as the kinetics of electron transfer from UA to ZnO due to the increased electric filed gradient, and reducing the applied voltage need to oxidize the UA compared to an unstrained one.

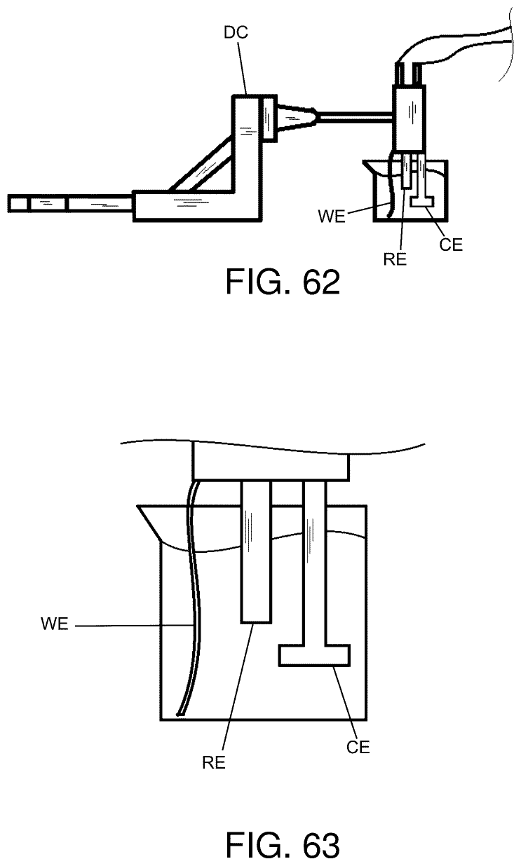

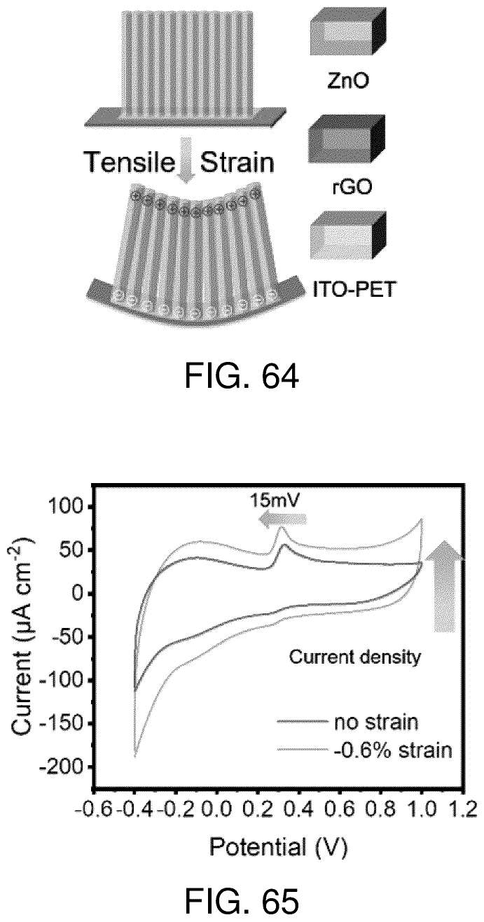

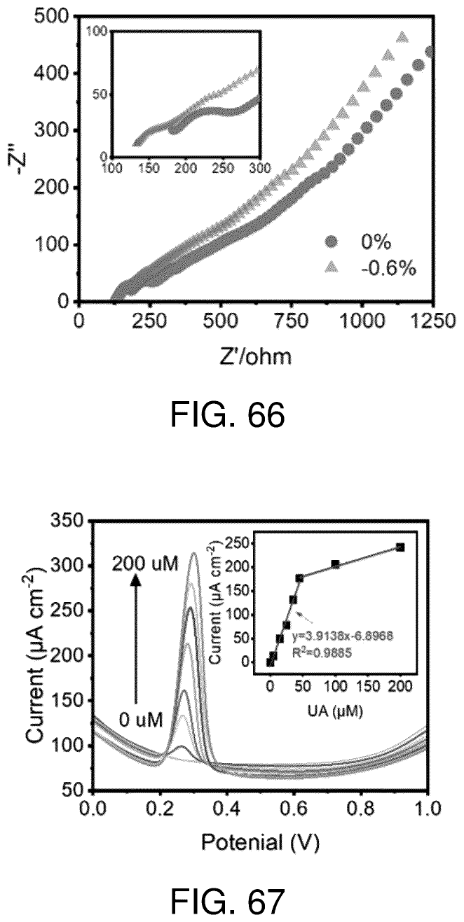

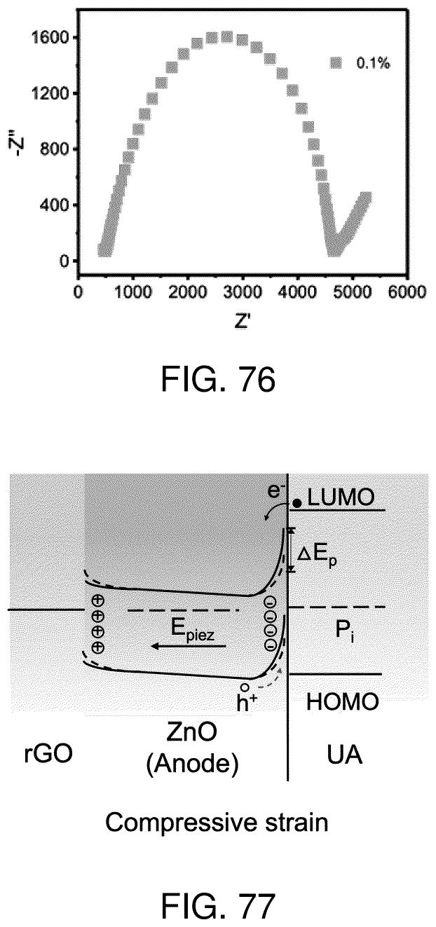

FIGS. 62-63 illustrate the experimental setup for evaluating the piezo-electrocatalysis process. The ZnO-rGO-ITO-PET electrode, otherwise known as the working electrode WE, is fixed at one end at the bottom of the testing beaker and at another fixed to a distance controller DC to facilitate the bending curvature of the electrode, thus changing the applied strain. During the bending, micro-cracks would appear on the ITO surface. Such cracks are detrimental to the electrical conductivity of the ITO-PET substrate when bending outward, as shown in FIG. 76. Therefore, the bending outward condition (compressive strain in the ZnO NRs) was not tested due to the difficulty of differentiating the effect of cracking and piezoelectricity. Moreover, based on our proposed piezo-electrocatalytic mechanism, the compressive strain would lead to poorer performance due to the higher charge transfer barrier, as shown in FIG. 77. As shown in FIG. 64, when a tensile strain is applied to the ZnO NRs, the positive charges appear at the top surfaces ([0001] facets), and the negative charges appear at the bottom surfaces ([0001] facets), forming an electric dipole and, thus, an internal piezoelectric field. As shown in FIG. 65, the CV curve of the ZnO-rGO-ITO-PET electrode in the presence of 50 μM UA in 0.1M PBS before and after bending. The shift of the oxidation peak (0.330 V to 0.315 V) and the overall current density increase upon bending indicates the piezoelectric effect in the ZnO NRs, which agrees well with the proposed enhancing mechanism of the piezo-electrocatalytic sensing process. The left shifting oxidation peak, i.e., the reduction of external potential required to oxidize the UA, and the increased current density suggest enhanced charge transfer, further promoting UA's oxidation. The reduction of the curvature in the EIS plot before and after applying strain, as shown in FIG. 66, unveils a reduced resistance of the ZnO-rGO-ITO-PET electrode, which also indicates the enhanced charge transfer from the electrolyte to the electrode due to the generated piezoelectric polarization charges.

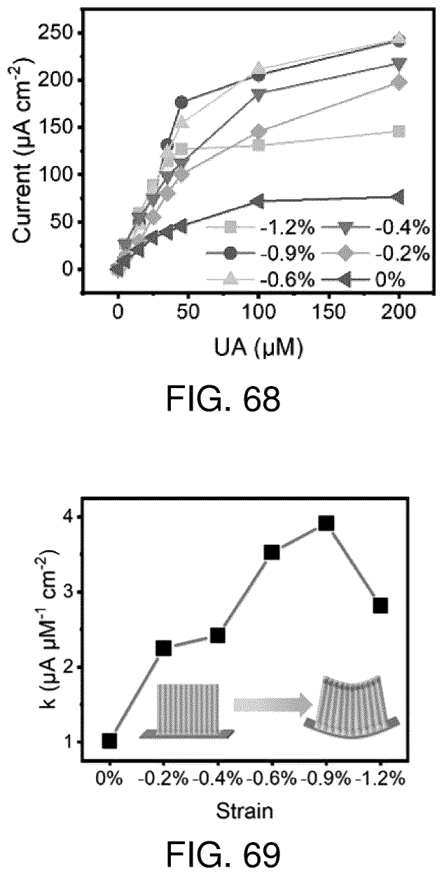

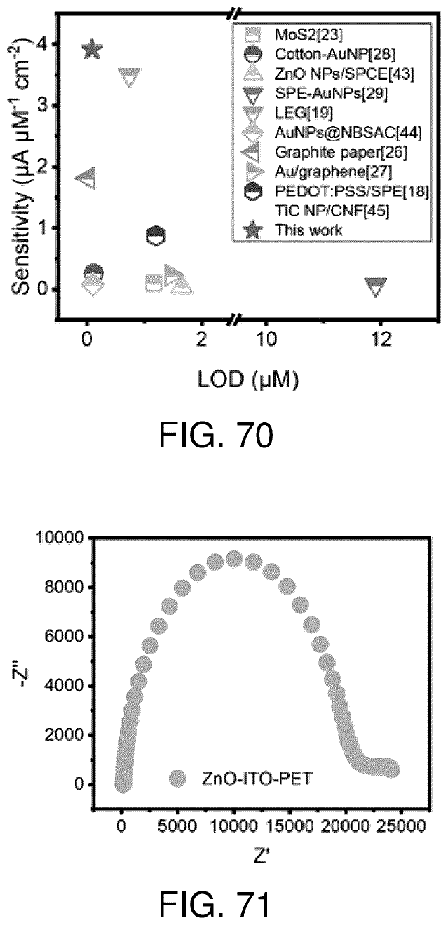

The catalytic sensing performance of the ZnO-rGO-ITO-PET electrodes towards UA was evaluated by the differential pulse voltammetry (DPV) method, which allows better sensitivity by eliminating the non-Faradaic current compared to CV. A set of typical DPV curves for the −0.9% strained ZnO-rGO-ITO-PET electrode at different concentrations of UA are shown in FIG. 67. The peak oxidation current increases linearly with the UA concentration with two linear slopes. The linear regression equations are: y₁(μA cm⁻²)=3.8139×(μM)−6.8968 (R²=0.9885) and y₂(μA cm⁻²)=0.4129×(μM)+160.219 (R²=0.9894). Such appearance of the two slopes might come from the monolayer adsorption followed by the multilayer adsorption of the target molecules. At low concentrations, the UA molecules adsorb to the ZnO NRs surface, forming a single adsorption layer. At high concentrations, the adsorption becomes multilayer due to the increased amount of UA molecules. The interaction between UA and the electrode surface varies due to the screening of the first adsorption layer. The impact of the piezoelectric effect on the electrochemical sensing performance of the ZnO-rGO-ITO-PET electrodes was further investigated with 0%, −0.2%, −0.4%, −0.6%, −0.9%, −1.2% applied strains, as shown in FIG. 68. The sensitivity k (the change of current per introduced UA concentration divided by the electrode area, μA μM⁻¹ cm⁻²) was calculated by linear fitting based on the first linear slope according to the applied strain, as shown in FIG. 69. The sensitivity of the ZnO-rGO-ITO-PET electrodes increases with the applied strain up to −0.9% by four folds compared with the conditions without strains. The sensitivity shows degradation at higher strains (−1.2%), which is thought to be due to the degradation of the ITO film, as shown in FIG. 75. Under such high deformation, enhancing electrochemical sensing performance by introducing higher piezopotential in ZnO NRs cannot compensate for the reduction of electrical conductance due to the cracking of substrate ITO film, resulting in reduced performance. The highest sensitivity can be achieved at −0.9% strain with a value of 3.91 μA μM⁻¹ cm⁻², better than all existing non-enzymic flexible electrochemical UA sensors, as shown in FIG. 70. The LOD of the sensors at −0.9% strain is calculated as 0.086 μM (S/N=3), superior to most of the reported flexible electrochemical UA sensors.

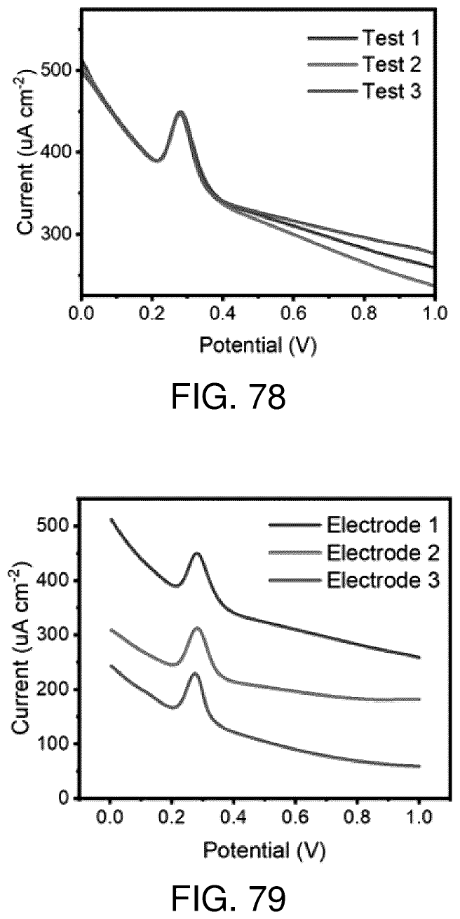

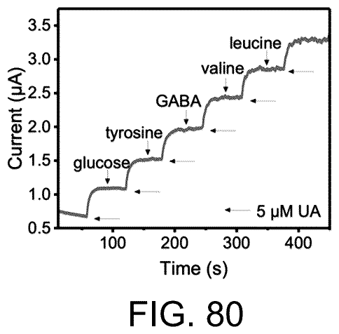

To evaluate the repeatability of the ZnO-rGO-ITO-PET electrodes, three consecutive DPV measurements using 25 μM UA (selected based on the normal sweat UA concentration in a healthy human, which is around 24.5 μM) in a 0.1M PBS solution were performed, as shown in FIG. 78. The relative standard deviation (RSD) of the current change towards introduced UA was calculated as 2.18%, showing that the as-fabricated ZnO-rGO-ITO-PET electrodes have a good anti-surface fouling ability towards UA oxidation product, with little variation of response between consecutive detection. The reproducibility of the ZnO-rGO-ITO-PET electrodes was explored by conducting DPV measurements using three distinct electrodes prepared under the same condition towards 25 μM UA in a 0.1M PBS solution, as shown in FIG. 79. The RSD was calculated as 2.16%, indicating the decent reproducibility of the ZnO-rGO-ITO-PET electrodes. The anti-interference performance of the ZnO-rGO-ITO-PET electrodes was studied using amperometric methods by step-wisely adding UA (5 μM at a time) and 2 mM interfering molecules (glucose, tyrosine, GABA, valine, and leucine) into the 0.1M PBS buffer solution sequentially, as shown in FIG. 80. The small perturbation from adding other molecules during the UA sensing process demonstrated the excellent selectivity of the ZnO-rGO-ITO-PET electrodes toward UA.

During the experimental testing of the ZnO-rGO-ITO-PET electrodes toward UA, all the chemicals were of analytical grade and used without further purification. Provided as a non-limiting example, reduced Graphene oxide (rGO powder, 15-20 sheets, 4-10% edge oxidized) and UA (99%) were obtained from Sigma Aldrich. Zinc acetate dihydrate (Zn(OOCCH₃)₂·2H₂O, >99.0%) and zinc nitrate hexahydrate (Zn(NO₃)₂·6H₂O, 99%) were obtained from Alfa Aesar. Hexamethylenetetramine (HMTA, >99%) was obtained from TCI America. Ethanol (ACS reagent) was obtained from VWR Analytical.

The rGO dispersion (1 mg/mL) was prepared by adding 5 mg rGO powder into 5 mL distilled water through 1 h sonication. At the same time, the ITO-PET (surface resistivity 60 Ω sq⁻¹, Sigma-Aldrich) was firstly cleaned by acetone, methanol, and deionized (DI) water, consecutively. After drying with an air gun, the ITO-PET was treated by O₂ plasma for 10 min. Then, an adequate amount of rGO dispersion was drop cast by a pipette to the O₂ plasma-treated ITO-PET surface at 85° C.

The ZnO NRs were synthesized via a hydrothermal method modified from the previously described approach. In the first step, the rGO-coated ITO-PET was immersed in a 10 mM Zn(OOCCH₃)₂·2H₂O in ethanol for 10 s and then annealed at 85° C. This step was repeated twenty times, followed by the final annealing at 100° C. for 30 min to obtain the ZnO seed layer on the rGO-coated ITO substrate. Then, the nanorod growth solution of 25 mM Zn(NO₃)₂·6H₂O and 25 mM HMTA, >99% was prepared. ZnO seed layer-coated rGO-ITO substrates were then immersed into the growth solution at 85° C. for 6 h. Finally, after thoroughly rinsing by DI water, ZnO NRs were obtained on the rGO-ITO substrate.

Morphology and composition of the as-synthesized ZnO on rGO-coated ITO substrates were characterized by a field-emission SEM (Hitachi S-4800) and EDS (Oxford X-MaxN 80 Silicon Drift Detector). Raman spectra were recorded using a Thermo Scientific DXR3xi Raman Imaging Microscope.

The strain is estimated according to the Saint-Venant theory for small bending deformation similar to the ref. The ITO-PET can be viewed as a beam structure with thickness x, width w, and length l. Dₘₐₓ is the maximum deformation of the free end of the ITO-PET strip. z₀ is the distance from the middle of the ITO-PET to the edge since the ZnO NRs grown region is in the middle. The strain induced in the middle of ZnO NRs film can thus be estimated by

$$ε = \pm 3 \frac{a}{2 l} \frac{{D}_{max}}{l} ( 1 - \frac{{z}_{0}}{l} ) .$$

For the catalytic experiments, the ZnO NRs-rGO-ITO-PET electrode WE was fixed at one end in the bottom of the testing beaker. A distance controller DC modulated the bending curvature. The estimation of the deformation was calculated based on previous reports. The electrochemical tests were executed on a CHI-660E electrochemical workstation using a three-electrode system. The as-prepared sample, a Pt sheet, and Ag/AgCl electrode were used as working electrodes, the counter electrode CE, and the reference electrode RE. The electrochemical tests were executed in 0.1 mM PBS with UA as a reference compound. All the computations and evaluations were carried out using the electrochemical cell, and each experimental setup was performed under standard atmospheric conditions.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions, and methods can be made within the scope of the present technology, with substantially similar results.

What is claimed is:

1. An electrochemical sensor configured to detect uric acid using piezo-electrocatalysis, wherein the sensor comprises:
a substrate; and
a piezoelectric semiconductor coupled to the substrate, wherein the piezoelectric semiconductor includes a nanostructured semiconducting zinc oxide catalyst.

2. The electrochemical sensor of claim 1, wherein the nanostructured semiconducting zinc oxide catalyst is capable of inducing piezoelectric polarization charges while under mechanical deformations.

3. The electrochemical sensor of claim 1, wherein the nanostructured semiconducting zinc oxide catalyst is a zinc oxide nanorod.

4. The electrochemical sensor of claim 1, wherein the zinc oxide nanorod has a terminal end connected to the substrate.

5. The electrochemical sensor of claim 1, wherein the substrate is constructed from a conducting material.

6. The electrochemical sensor of claim 1, wherein the substrate is flexible.

7. The electrochemical sensor of claim 6, wherein the substrate is an indium tin oxide coated polyethylene terephthalate (ITO-PET) substrate.

8. The electrochemical sensor of claim 7, wherein the piezoelectric semiconductor and the ITO-PET substrate are coated with a drop-casted reduced-graphene-oxide (rGO) coating.

9. The electrochemical sensor of claim 8, wherein an aspect ratio of the piezoelectric semiconductor is at least 15.

10. The electrochemical sensor of claim 8, wherein the piezoelectric semiconductor has redox peaks ranging from at least one of around 0.3V to 0.4V and around 0V to 0.1V.

11. The electrochemical sensor of claim 1, wherein the piezoelectric semiconductor is hydrothermally synthesized to the substrate.

12. A wearable electrocatalytic device comprising an electrochemical sensor according to claim 1.

13. The wearable electrocatalytic device of claim 11, wherein the wearable electrocatalytic device non-invasively monitors the uric acid.

14. A method of manufacturing an electrochemical sensor configured to detect uric acid using piezo-electrocatalysis, the method comprising the steps of:
providing a substrate;
disposing the substrate in a seed solution including zinc, the seed solution configured to produce a zinc oxide seed layer on the substrate;
disposing the substrate with the zinc oxide seed layer into a growth solution, the growth solution configured to form a semiconducting nanostructured zinc oxide catalyst on the substrate; and
forming a semiconducting nanostructured zinc oxide catalyst on the substrate.

15. The method of claim 14, further comprising a step of oxygen plasma treating the substrate before the step of disposing the substrate in the seed solution.

16. The method of claim 15, wherein the substrate is an indium tin oxide coated polyethylene terephthalate (ITO-PET) substrate.

17. The method of claim 14, further comprising a step of coating the substrate with a drop casted reduced-graphene-oxide (rGO) coating.
